(19) United States
(12) Patent Application Publication
(10) Pub. No.: US 2015/0149250 A1
(43) Pub. Date: May 28, 2015

(54) METHOD, APPARATUS, AND COMPUTER PROGRAM PRODUCT TO ASCERTAIN SUPPLY AND DEMAND ANALYTICS AND OUTPUTTING EVENTS BASED ON REAL-TIME DATA FOR PROXIMITY AND MOVEMENT OF INDIVIDUALS AND OBJECTS

(71) Applicant: ZIH Corp., Lincolnshire, IL (US)

(72) Inventors: Michael Fein, Ann Arbor, MI (US); Anthony R. Brown, Spring Grove, IL (US); John Huffman, Lincolnshire, IL (US); Robert Grom, Lake Zurich, IL (US); Karl Torchalski, Arlington Heights, IL (US); James J. O'Hagan, McHenry, IL (US)

(21) Appl. No.: 14/556,753

(22) Filed: Dec. 1, 2014

Related U.S. Application Data
(63) Continuation-in-part of application No. 13/942,316, filed on Jul. 15, 2013, now Pat. No. 9,002,485.
(60) Provisional application No. 61/831,990, filed on Jun. 6, 2013.

(51) Int. Cl. G06Q 30/02; G06Q 10/10; G06Q 10/08

(52) U.S. Cl. CPC G06Q 30/0205; G06Q 10/087; G06Q 10/10; G06Q 30/0201; G06Q 30/0202
USPC 705/7.31; 705/28

(57) ABSTRACT

A method, apparatus and computer program product are provided herein for ascertaining supply and demand analytics and outputting event. An example method comprises receiving blink data comprising at least a tag unique identifier from a tag, calculating, using a processor, tag location data, wherein the tag location data is based on the blink data, and correlating the tag location data to provider location data.

### CROSS-REFERENCE TO RELATED APPLICATION

This application claims priority from and is a Continuation-in-Part of U.S. patent application Ser. No. 13/942,316 filed Jul. 15, 2013, which claims priority to U.S. Provisional Patent Application No. 61/831,990 filed Jun. 6, 2013, the contents of each are incorporated by reference in their entirety herein.

### FIELD OF THE INVENTION

Embodiments discussed herein are related to radio frequency locating and, more particularly, to systems, methods, apparatuses, computer readable media and other means for providing supply and demand analytics.

### BACKGROUND

Applicant has discovered problems with existing methods and systems for supply and demand management. Through applied effort, ingenuity, and innovation, Applicant has solved many of these identified problems by developing a solution that is embodied by the present invention and described in detail below.

### BRIEF SUMMARY

Systems, methods, apparatuses, and computer readable media are disclosed for providing real-time collection and analysis of provider supply and demand, events, and statistics during a sporting event or other group activity using a location system, such as a radio frequency location system, as herein described.

A method comprising receiving blink data comprising at least a tag unique identifier from a tag, calculating, using a processor, tag location data, wherein the tag location data is based on the blink data, and correlating the tag location data to provider location data.

In some embodiments, the method further comprises aggregating demand, correlating the demand to the tag location data and the provider location data, and generating experience enhancement data based on the demand correlated to the tag location data and the provider location data.

In some embodiments, the experience enhancement data is defined by at least one of provider data, transaction data, or experience data, the provider data, the transaction data, or the experience data being associated to at least one of the tag location data, the provider location data, mobile provider location data, or sensor position data.

In some embodiments, the method further comprises utilizing the experience enhancement data to generate analytic data, the analytic data comprising at least one of provider data, transaction data, or experience data, and calculating, using the processor, provider supply based on the analytic data.

In some embodiments, the demand is defined by at least one of a category, a sub-category, or a meta-category, the category, the sub-category, or the meta-category identifying at least one of a provider, monitored individual, monitored area, product, service, or experience.

In some embodiments, the at least one of the category, sub-category, or meta-category is based in part on one or more factors.

In some embodiments, the method further comprises generating, using the processor, historical analytic data, and generating, using the processor, predictive analytic data, wherein the historical analytic data and the predictive analytic data are based on at least one of the tag location data, the provider location data, or monitored individual location data.

In some embodiments, the historical analytic data comprises at least one of weather data, provider data, demographic data, monitored area data, or periodic data.

In some embodiments, the predictive analytic data comprises at least one of weather data, provider data, monitored area data, demographic data, or periodic data.

In some embodiments, the method further comprises generating an alert based on at least one of tag location data, provider location data, provider supply, analytic data, or demand, the alert comprising at least one of a text message, a promotion, an email, an invitation, a message, or a notification, transmitting the alert, and outputting the alert.

In some embodiments, the alert is transmitted to one or more application devices.

In some embodiments, the method further comprises receiving the blink data from a mobile provider tag, and calculating mobile provider tag location data, wherein the mobile provider tag location data is based on the blink data from the mobile provider tag and wherein the provider location data further comprises the mobile provider location data.

In some embodiments, the method further comprises tracking at least one of the tag location data, the provider location data, mobile provider location data, or sensor position data.

In some embodiments, the method further comprises allocating the provider supply based on demand, and distributing the provider supply.

In some embodiments, the method further comprises reallocating the provider supply based on the demand.

In some embodiments, the method further comprises tracking, via at least one of the tag location data or sensor position data, one or more providers simultaneously.

In some embodiments, the method further comprises transmitting an event indication, via the tag, to verify an event.

In some embodiments, transmitting the event indication, via the tag, to verify the event comprises generating a signal via one or more buttons, links, or icons.

In some embodiments, the tag location data is correlated to object data.

In some embodiments, the object data comprises at least one of an expiration date, active duration, or inactive duration.

In some embodiments, the method comprises receiving blink data from a tag, calculating, using a processor, tag location data, wherein the tag location data is based on the blink data, associating tag location data to provider location data, determining provider information based on the associated tag location data and provider location data, and transmitting the provider information.

In some embodiments, the tag is associated to sensor position data received from an identification sensor.

In some embodiments, the method further comprises allocating one or more providers to a monitored area based on at least one of an event, periodic data, or predictive analytic data.

In some embodiments, allocating the one or more providers to the monitored area based on the at least one of the event or the predictive analytic data comprises transmitting a request, the request defined by at least one of the provider location data or the tag location data, determining the predictive analytic data based on at least one of the request, the event, provider data, demographic data, weather data, transaction data, experience data, or one or more rules, generating an alert based on the request and the predictive analytic data, wherein the alert comprises at least one of a text message, a promotion, an email, an invitation, a message, or a notification, and transmitting the alert.

In some embodiments, the method further comprises determining one or more metrics based on at least one of the tag location data, the provider data, the demographic data, the weather data, the transaction data, the experience data, the one or more rules, or sensor position data.

In some embodiments, the method further comprises verifying provider location data based on at least one of the sensor position data or the tag location data.

In some embodiments, the method further comprises transmitting analytic data correlated to the at least one of the event, the periodic data, or the predictive analytic data to a visualization system, wherein the visualization system is configured to generate graphics, displays, or visualizations, and outputting the analytic data.

In some embodiments, the method further comprises calculating a location summary based on at least one of sensor position data or tag location data, and outputting analytic data based on the location summary.

In some embodiments, the method further comprises tracking, via at least one of the provider location data or sensor position data, one or more providers simultaneously.

In some embodiments, the method further comprises transmitting an event indication, via the tag, to verify an event.

In some embodiments, transmitting the event indication, via the tag, to verify the event comprises generating a signal via one or more buttons, links, or icons.

In some embodiments, the method further comprises receiving an audio event correlated to the tag location data and provider location data, and outputting the audio event to at least one of an alert system, application device, or analytics system.

In some embodiments, the tag location data is correlated to object data.

In some embodiments, the object data comprises at least one of an expiration date, active duration, or inactive duration.

A method comprising receiving blink data from a mobile provider tag, and calculating mobile provider tag location data, wherein the mobile provider tag location data is based on the blink data from the mobile provider tag and wherein provider location data comprises the mobile provider location data.

In some embodiments, the method further comprises tracking at least one of a tag, tag location data, the provider location data, the mobile provider location data, or sensor position data.

In some embodiments, the method further comprises aggregating demand, correlating the demand to the mobile provider tag location data and the mobile provider location data, and generating experience enhancement data, wherein generating the experience enhancement data is based on the aggregated demand correlated to the mobile provider tag location data and the mobile provider location data.

In some embodiments, the experience enhancement data is defined by at least one of provider data, transaction data, or experience data, the provider data, the transaction data, or the experience data being associated to at least one of the tag location data, provider location data, the mobile provider location data, or sensor position data.

In some embodiments, the method further comprises utilizing the experience enhancement data to generate analytic data, wherein the analytic data comprises at least one of provider data, transaction data, or experience data, and calculating, using the processor, provider supply based on the analytic data.

In some embodiments, the demand is defined by at least one of a category, a sub-category, or a meta-category, the category, the sub-category, or the meta-category identifying at least one of a provider, monitored area, product, service, or experience.

In some embodiments, the at least one of the category, sub-category, or meta-category is based on one or more factors.

In some embodiments, the method further comprises generating, using the processor, historical analytic data, and generating, using the processor, predictive analytic data, wherein the historical analytic data and the predictive analytic data are based on at least one of the mobile provider tag location data or the mobile provider location data.

In some embodiments, the historical analytic data comprises at least one of weather data, provider data, demographic data, monitored area data, or periodic data.

In some embodiments, the predictive analytic data comprises at least one of weather data, provider data, monitored area data, demographic data, or periodic data.

In some embodiments, the method further comprises generating an alert based on at least one of tag location data or the mobile provider location data, wherein the alert comprises at least one of a text message, a promotion, an email, an invitation, a message, or a notification, transmitting the alert, and outputting the alert.

In some embodiments, the alert is transmitted to one or more application devices.

In some embodiments, the method further comprises allocating the provider supply based on a demand, and distributing the provider supply.

In some embodiments, the method further comprises reallocating the provider supply based on the demand.

In some embodiments, the method further comprises tracking, via at least one of the mobile provider tag location data or sensor position data, one or more providers simultaneously.

In some embodiments, the method further comprises transmitting an event indication, via the tag, to verify an event.

In some embodiments, transmitting the event indication, via the tag, to verify the event comprises generating a signal via one or more buttons, links, or icons.

An apparatus comprising at least one processor and at least one memory including computer program code, the at least one memory and the computer program code configured to, with the processor, cause the apparatus to at least receive blink data comprising at least a tag unique identifier from a tag, calculate, using a processor, tag location data, wherein the tag location data is based on the blink data, and correlate the tag location data to provider location data.

A computer program product comprising at least one non-transitory computer-readable storage medium having computer-executable program code portions stored therein, the computer-executable program code portions comprising program code instructions for receiving blink data comprising at least a tag unique identifier from a tag, calculating, using a processor, tag location data, wherein the tag location data is based on the blink data, and correlating the tag location data to provider location data.

Additional features and advantages of the present invention will be set forth in portion in the description which follows, and in portion will be obvious from the description, or may be learned by practice of the invention. The features and advantages of the invention will be realized and attained by means of the elements and combinations particularly pointed out in the appended claims.

It is to be understood that both the foregoing general description and the following detailed description are exemplary and explanatory only and are not restrictive of the invention as claimed.

Embodiments of the present invention may provide for automatic recognition of supply, demand, and events during a sporting event through the processing of real time (or near real time) data regarding location, change in location, change in acceleration, orientation, sensor position data, or the like, for providers associated with a sporting event or other group activity. Once such supply, demand, and events have been defined or identified they may be used to operate, control, or drive analytics or control systems such as, without limitation, visualization systems, analytics systems, statistics systems, camera control systems, and XML feed/IM feed systems.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1A illustrates an exemplary real time location system in accordance with some embodiments of the present invention;

FIG. 1B is a flowchart showing an exemplary process that may be utilized to provide supply and demand analytics in accordance with some embodiments of the present invention;

FIG. 2 illustrates an exemplary system for providing supply and demand analytics in accordance with some embodiments of the present invention;

FIG. 3 illustrates a block diagram of components that may be included in devices for performing operations in accordance with some embodiments of the present invention; and

FIGS. 4A-7 provide flowcharts of some exemplary processes that may be used in providing performance analytics in accordance with some embodiments of the present invention.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein. Rather, these embodiments are provided so that this disclosure will satisfy applicable legal requirements. Like numbers refer to like elements throughout.

### Overview

Existing performance analytics of sporting events have drawbacks in providing accurate data about events and provider actions that occur during a game and/or group activity. Provider data is often out-of-date, stored in disparate provider managed locations, manually collected by individuals, or not collected at all. Review of supply, demand, and events from a game and/or group activity often requires individuals to compile data for analysis after a game and/or group activity has occurred. This review of the data after the game and/or group activity has occurred neglects real-time (or near real-time) opportunities that may be present such as sales, response, and/or experience enhancement opportunities.

Embodiments of the present invention are directed to methods, systems, apparatuses, and computer readable storage media for providing real-time collection of data and analysis of supply and demand during an activity such as by using radio frequency location systems and radio frequency identification (“RFID”) by implementing and/or otherwise executing an analytic engine, alert module, audio module, visualization engine, central processor/hub, payment system, and/or the like.

As used herein, the terms “data,” “content,” “information” and similar terms may be used interchangeably to refer to data capable of being captured, transmitted, received, displayed and/or stored in accordance with various example embodiments. Thus, use of any such terms should not be taken to limit the spirit and scope of the disclosure. Further, where a computing device is described herein to receive data from another computing device, it will be appreciated that the data may be received directly from the other computing device or may be received indirectly via one or more intermediary computing devices, such as, for example, one or more servers, relays, routers, network access points, base stations, and/or the like. Similarly, where a computing device is described herein to send data to another computing device, it will be appreciated that the data may be sent directly to the another computing device or may be sent indirectly via one or more intermediary computing devices, such as, for example, one or more servers, relays, routers, network access points, base stations, and/or the like.

A location system, such as the location system described herein, may be configured to provide for automatic tracking of data to ascertain supply and demand through the processing of real time data (or near real time data) regarding location, change in location, orientation, or the like, for providers, patrons, and/or monitored individual based on an analysis of relevant data as described in detail below. The term “provider” as used herein refers to employees, vendors, merchants, personalities (e.g., mascots, celebrities, public figures, VIP assistants, etc.), security personnel, medical personnel, first responders, and related objects (e.g., products, souvenirs, equipment, fixtures, and any other object proximate a group activity). For example, a provider may be a concession vendor at a football game. In other examples, a provider may be a product, such as one or more beers, a case of beers, and/or the like.

As used herein, the term “patrons” refers to consumers, sporting event fans, guests, trade show and/or convention participants. In some embodiments, a patron may be correlated to patron data which may include patron profile data (e.g., patron name, address, and/or other identifying data), related transaction data, and/or the like. The term “monitored individuals” refers collectively to patrons, providers, or other individuals who are equipped to carry location tags and/or sensors. For example, patrons may be equipped to carry location tags upon receipt of a lanyard, for example, upon entry into a monitored area. In some embodiments, each patron identified as a VIP may receive a location tag. In other embodiments, a location tag may be provided to a sample of individuals upon entry into a monitored area as described below. The location system may include a sensor at venue entryways to identify patrons associated with locations tags upon entry into the venue.

As used herein, the term “blink data” includes characteristics of the tag signal that allow a tag signal to be recognized by a receiver so the location of the RF location tag may be determined by the location system. Blink data may also include one or more tag data packets. Such tag data packets may include any data from the tag that is intended for transmission such as, for example tag data and a tag-individual correlator. In the case of time difference of arrival (TDOA) systems, the blink data may be or include a specific pattern, code, or trigger that the receiver (or downstream receiver processing and analytics system) detects to identify that the transmission is from a RF location tag (e.g., an ultra-wideband “UWB” tag). Blink data may include, data including a tag unique identifier (“tag UID”) and other data that may be apparent to one of skill in the art in view of the foregoing description. The tag unique identifier may identify a particular location tag.

As used herein, the term “tag” may include a tag having a UWB transmitter, that transmits a signal comprising a burst (e.g., 72 pulses at a burst rate of 1 Mb/s), and optionally, a burst having a tag data packet that may include tag data elements that may include, but are not limited to, a tag unique identifier as described above, other identification information, a sequential burst count, stored tag data, or other desired information for object or personnel identification, inventory control, etc.

As used herein, the term “tag location data,” may include blink data which has been received and processed by one or more of the receivers and/or central processor/hubs. Further, in some embodiments, the tag location data may be correlated with provider location data. The term “provider location data,” may include blink data which has been correlated to a provider. The provider location data correlated to the blink data may be received and processed by one or more receivers, central processor/hubs, and/or the like. Furthermore, the term “monitored individual location data,” may include blink data which has been correlated to a monitored individual. The monitored individual location data correlated to the blink data may be received and processed by one or more receivers, central processor/hubs, and/or the like.

In some embodiments, a provider may be correlated to provider data. Provider data may include provider location data, provider information (e.g., provider type, business name, provider name, business address, designated service area, etc.), employee profile data (e.g., employee name, address, designated service area, etc.), role data, performance statistics, and other data that may be apparent to one of skill in the art in view of the foregoing description and such data may be stored in one or more databases.

Further provider data may include mobile provider data. The term “mobile provider data” and similar terms may be used interchangeably to refer to any cart, concession, tray, trailer, truck, kiosk, device, object, provider or the like that may be able to move or be moved. For example, a central processor/hub may track the location of sensor position data correlated to a mobile provider, such as a cotton candy tray. An analytics engine may further analyze the location of the tag and/or sensor position data correlated to the vendor carrying the tray of cotton candy.

To ascertain provider information associated with providers in proximate locations, the location system may determine provider information based on tag location data, sensor position data, and/or the like. In some embodiments, the determined provider information may be based on the associated tag location data, provider location data, and/or the like. The analytic engine may transmit the provider information to the alert module, visualization engine, report module, application device, payment system, and/or the like. For example, the analytic engine may determine the nearest security personnel may be Security Guard Thomas Jones located in a monitored area, such as Concourse A.

In some embodiments, such provider data may be pre-defined and stored in association with tag unique identifiers or sensor identifiers which may provide provider location data to the central processor/hub. In other embodiments, the provider data may also be “learned” by the system as a result of received tag data, sensor position data, transaction data (e.g. data learned by the system in relation to a sale, promotion, agreement, transaction, and/or the like), experience data (e.g., data pertaining to types of experiences such as concerts, sporting events, entertainment events, competitive events, etc.), and/or the like.

In some embodiments, as described in greater detail below, provider data may be updated by the system (i.e., to produce a real-time or rapid data set) as a result of received tag data, sensor position data, transaction data, experience data, and/or the like, In some embodiments, provider data may be used in the analytics engine to assist in determining experience enhancement data, predictive analytic data, historical analytic data, and/or the like.

As used herein, the term “experience enhancement data,” may include data associated with analyzing the quality, value, extent, or the like of an experience. Experience enhancement data may be identified by one or more routes, traffic patterns, movements, trends, and/or the like characterized by learned data, change, activity, progress, and/or the like. Experience enhancement data may be based, in part, on provider data, transaction data, experience data, monitored area (e.g. a venue, stadium, arena, park, section, floor, level, aisle, room, restroom, entry point, exit point, parking area, area proximate the venue, and/or the like), product, service, and/or the like. In some embodiments, experience enhancement data may be based on demand as associated with tag location and/or provider location data. The location system described herein may classify demand by a taxonomic structure, such as a category, sub-category, or meta-category. For example, the aggregation module may classify demand showing beverage units sold as having a category “beverage,” sub-category, “alcohol,” meta-category “Beer Brand,” etc. The analytic engine may correlate the demand generated by the aggregation module showing 500 sold units of meta-category “Beer Brand A” and 200 units sold of meta-category “Beer Brand B” to the tag location data and provider location data transmitted to the central processor/hub as each transaction occurred.

The term “payment system” as used herein may refer to a system via which a transaction may be completed. A payment system may be fixed (e.g. a point of sale transaction conducted via a cash register located at a concession stand, store, restaurant, and/or the like). As used herein, the term “application device” may include a device, such as a mobile device, smart device, RF device, or the like, that may access one or more programs, servers, networks, central computers, etc. The interface of the application device may operate via WiFi, Bluetooth, near field communication (NFC), quick response code (QR), barcodes, and/or the like. In other embodiments, a payment system may be mobile (e.g., a point of sale transaction conducted via an application device, such as an application device running a point of sale software). The location system, such as the location system described herein, may generate experience enhancement data that defines and/or optimizes sales trends based, in part, on the tag locations of the providers, payment systems, and the generated point of sale data.

In some embodiments, the point of sale data may be transmitted directly and/or indirectly via a tag or other transmitter. The tag location data may be transmitted from the tag to a receiver for computation by the central processor/hub and analysis performed by the analytic engine. The analytic engine may programmatically utilize machine learning to develop a particular pattern recognition algorithm based on statistical inferences. Such machine learning may be unsupervised (e.g., determining a hidden structure from unlabeled data) or supervised (e.g., inferring a function from a set of training patterns with each training pattern placed into a classifier which can be used to map new data). The algorithm may determine the classification of new data based, in part, on such learned training patterns.

For example, a location system may determine from provider location data, payment system data, and point of sale data received by the analytic engine that each vendor producing at least $1,000 in revenue during a quarter within a game has a route that services at least 10 monitored individuals in a monitored area (e.g. VIP suites). Such sales trends may be used by the location system to inform the sales routes of other providers during subsequent quarters, events, and/or the like and, thereby, increasing productivity and revenue.

In other example embodiments, the location system described herein may use similar pattern recognition algorithms as described above to generate experience enhancement data to further analyze demand. For example, the analytic engine may determine via a pattern recognition algorithm that when a provider, such as Beer Vendor A, sells beer in Concourse A that provider's sales volume doubles when compared to the sales volume achieved in Concourse B. In another example, experience enhancement data may provide data based on one or more factors, such as the weather, experience, monitored area, time of day, etc. For example, when the weather is below 70 degrees Fahrenheit in the shaded area of the venue during an early evening game, coffee sales increase, while ice cream sales decrease.

In another example embodiment, a patron operated application device (e.g., a smart phone carried by a patron) may be correlated to a tag. The interface of the application device may be operate via WiFi, Bluetooth, NFC, QR, barcodes and/or the like. One or more receivers may receive transmissions from the tag correlated to the patron operated application device and transmit the blink data to a central processor/hub. The central processor/hub may process the received data to determine the tag location. The central processor/hub may transmit the tag location data to one or more processors, such as an analytic engine. The analytic engine may use one or more modules (e.g., processing engines) and one or more databases to identify the patron operated application device and, thereby, identify each patron associated with each tag. Further, the tag location of the patron operated application device and/or sales data can be transmitted to the analytic engine. The analytic engine may programmatically utilize machine learning to develop a particular pattern recognition algorithm based on statistical inferences that includes point of sale data and tag location data correlated to patron operated application devices, provider location tags, payment systems, and/or the like.

Such experience enhancement data may be used by the location system, via the analytics engine, to generate analytic data. The term “analytic data” may include data that relates to other data or is programmatically determined by one or more systems discussed herein. Analytic data may be based on provider data, patron data, transaction data, experience data, reports, and/or the like as described above. For example, analytic data generated by the location system may optimize Beer Vendor A's sales route(s) based on sale points, provider location data, and/or the monitored individual location data demonstrating Beer Vendor A's revenue received and/or product sold in a monitored area.

In some embodiments, analytic data may be used by the analytics engine to calculate provider supply. Further, the provider supply may be allocated, distributed, and/or reallocated based on demand. For example, if the temperature decreases during a football game, the location system may determine a decrease in sales for frozen cappuccinos in Section 100. The location system may generate an alert as described herein below to inform Café Vendor A of the provider's short-term need to sell coffee or hot chocolate. In further examples, such provider supply may be optimized at re-supply points as determined by the location system. For example, the location system may determine the revenue lost when a provider leaves the aisle to re-stock the supply. The location system may further determine the most profitable re-supply points based on the tag location data, sensor position data, historical data (e.g., previous transaction data and/or traffic patterns), provider data, patron data and/or the like.

Embodiments of the present invention may generate, by a processor, analytic data that may be historical analytic data, predictive analytic data, and/or the like. The term “historical analytic data,” may include facts, statistics, and/or other information collected together for reference or analysis. The term “predictive analytic data,” may include facts, statistics, and/or other information relating to or having the effect of generating forward-looking analysis, results, explanations, conclusions, reports, etc. Historical analytic data and/or predictive analytic data may be based on at least one of the tag location data, provider location data, or monitored individual location data. In some embodiments, the historical analytic data and/or predictive analytic data may include weather data, provider data, monitored area data, demographic data, transaction data, or periodic data (e.g., data based on measurements, intervals, points in time, or the like that may indicate hours, minutes, seconds, calendar information, and/or the like). For example, the analytic engine may generate historical analytic data that illustrates over the past five years in the month of August there has been an increase, for a given venue, in sales for peanuts when the price of beer is less than $5.00 and the temperature in a monitored area is greater than 80 degrees Fahrenheit.

In further examples, the analytic engine may generate predictive analytic data that predicts a reduction in the number of food vendors required for a monitored area for a particular day based on the amount of pre-purchased food packages determined by the analytic engine via a pattern recognition algorithm as described above.

Analytic data generated by the analytics engine may be received by the alert module to generate an alert. As used herein, the term “alert” may include a text message, promotion, email, invitation, message, or notification. The alert may be transmitted to one or more application devices, databases, and/or the like. In an example embodiment, a location system, such as the system described herein, may generate an alert in the form of a text message that includes a promotion advertising unsold product. For example, the alert module may generate an alert when Hot Dog Provider A has unsold hot dogs at the bottom of third quarter. The alert module may output the generated alert advertising the hot dogs to application devices (e.g., smart phones carried by patrons). In other embodiments, the alert module may transmit the alert to one or more systems (e.g. an analytics engine, visualization engine, communications interface, and/or the like) for analysis or to advertise such promotions. For example, the alert module may transmit the hot dog promotion to an electronic advertising and stadium signage system (e.g., systems that include ads, scoreboards, and/or the like).

In other examples, the location system described herein may generate an alert, via the alert module, to attendees, providers, or the like that includes a message to evacuate the venue based on tag location data, one or more rules, sensor position data, or the like associated with a monitored area. In another example embodiment, the alert module may generate an alert to an application device held by Employee A. The alert may include a message to notify Employee A to take in aisle inventory to Employee B. Such alerts aid in increasing sales efficiency, optimizing sells revenue, and reducing re-stocking inefficiencies.

In further examples, such data generated by the analytics engine may be utilized to allocate one or more providers to a monitored area based on an event, periodic data, predictive analytic data, and/or the like. The term “event” and similar terms may be used interchangeably to refer to an occurrence that requires use of providers, for example, first responders, emergency personnel, security personnel, personalities, related objects, and/or the like. In some example embodiments, an event may also include an occurrence such as receipt of a service and/or product, request for a service and/or product, a medical and/or security situation. For example, the analytics engine may determine a demand for alcohol in Section 100 meets and/or exceeds a threshold based on the alcohol sales data and patron density as identified via sensor position data (as described in detail below) and/or tag location data. The analytics engine may generate predictive analytic data predicting the need for additional security personnel in Section 100. The additional security personnel may be allocated to Section 100 in order to prevent previous issues as determined by historical analytic data generated by the analytics engine or predictive analytic data generated by the analytics engine that relates to alcohol consumption. Providing the ability to locate emergency and security personnel improves personnel deployment and the response time for such deployments based on proximity.

In some embodiments, the location system may provide for event indications (e.g. generating a signal to indicate the happening of an event) in real time (or near real time). Such event indications may be transmitted via a tag that includes a tag unique identifier to verify the event. In some embodiments, the location system may generate event indications via one or more buttons, links, icons, and/or the like to verify performance of an event. For example, a provider of cleaning services may press an event button (e.g. an event service button) when a restroom has been serviced or when a trash can has been serviced. The pressing of an event button sends provider location data to the location system. Tracking such data ensures all areas are clean, while managing time and resources efficiently.

In another example, the location system may indicate cleaning services are needed based on the number of patrons located within a monitored area as indicated by sensor position data and or tag location data.

In other examples, a provider of entertainment services may press an event button to dispatch emergency personnel. Such event indications may be output to a variety of systems including, without limitation, an analytics engine, visualization engine (e.g., an enhanced television broadcast system or computer graphics visualization system), an alert module, a camera control system, a statistics system, etc.

In another embodiment, the analytics engine may calculate a location summary based on at least one of sensor position data or tag location data. Sensor position data may be transmitted directly or indirectly via a tag or other transmitter upon the configuration of a sensor to communicate with a receiver. For example, in some embodiments, a plurality of sensors may be connected to a dedicated antenna or transmitter which may transmit sensor position data to one or more receivers.

In some embodiments, a visualization engine may output analytic data generated by the analytics engine based on the location summary correlated to at least one of sensor position data or tag location data. In example embodiments, a visualization engine may output the analytic data in the form of a heat map, fractal map, tree map, choropleth map, prism map, chart, histogram, bar graph, and/or any diagram showing a relation between variable quantities. For example, the analytics engine may calculate a location summary based on the sensor position data transmitted via a tag associated with each popcorn vendor proximate a monitored area. The visualization engine may generate a heat map based on the calculated location summary to depict the location of each popcorn vendor proximate a monitored area.

In other examples, the visualization engine may generate a diagram that analyzes transaction data. For example, the visualization engine may generate a diagram illustrating top performing sales, products, services, etc. In further embodiments, the visualization engine may generate a diagram that analyzes aggregated data received from the aggregation module. For example, a graph illustrating top food sales having a category “food,” a sub-category, “type of food,” a meta-category “food item,” etc.

Further, in other embodiments, a location system, such as the location system described herein, may track the tag, tag location data, provider location data, mobile provider location data, sensor position data, and/or the like. In some embodiments, the analytic engine may track providers (e.g., an object such as a case of beer), to determine inventory. The tag associated with the case of beer may transmit tag location data identifying the location of the case of beer throughout the supply chain to a receiver. The central processor/hub may receive the tag location data from the receiver. In some embodiments, the central processor/hub may compute the tag location data to provide such data to the analytic engine. Transaction data associated with tag location data, sensor position data, and or monitored area data (e.g, an aisle or supply room) may be tracked and provided to the analytic engine to generate predictive analytic data such as the supply of inventory (e.g., cases of beer) required for future games and/or group activities.

In other examples, the analytic engine may track the expiration of a provider (e.g., a food product), via a tag and/or periodic data (e.g., product receipt date). Such tracking may be utilized to assist in product recalls and investigations which may reduce liability. Further, the analytic engine may track providers, such as food and beverage products, included in offerings, packages, promotions, and/or the like. The location system may track a beverage in such promotions (e.g., an “all-you-can-drink” promotion) via a tag, sensor position data, barcode, and/or the like and further determine when the product or service may be used. For example, the location system may enforce a lock-out period for a self-serviced beverage. During the lock-out period, the cup with the attached sensor, tag, and/or barcode may not be re-filled.

In other embodiments, the central processor/hub may track one or more providers simultaneously. For example, the central processor/hub may track the locations of multiple mascots. In some embodiments, the alert module may generate an alert when identical mascots are within (or near) the same monitored area. In an example embodiment, the analytics engine may track provider location data as such data correlates to a monitored area. For example, the central processor/hub may track the monitored areas visited by the mascot.

The analytic engine may analyze periodic data and one or more rules correlated to provider location data, tag location data, and/or sensor position data. For example, the analytic engine may track a provider's (e.g., a mascot or other personality), service time and contract rules as correlated to the mascot's location in a monitored area.

In other embodiments, mobile provider location data may be tracked to determine the locations of each of the mobile providers proximate the venue. The analytics engine may output tracked data to a report module, alert module, application device, one or more databases, and/or the like.

In other embodiments, the audio module may be configured to receive an audio event correlated to tag location data and provider location data. The term “audio event” may include any sound that may be recorded, transmitted, reproduced, and/or the like. The audio module may be further configured to output the audio event to the alert module, application device, analytics engine, and/or the like. For example, a mascot may speak a request for emergency services into an audio receiver, such as a microphone. The audio module may receive the request for emergency services. The audio module may be further configured to output the request for emergency services to an application device, alert module, and/or the like.

Embodiments of the present invention are illustrated in the appended figures and description below. As will be apparent to one of ordinary skill in the art in view of this disclosure, the inventive concepts herein described may be applied to various applications including, without limitation, during sports or group activities such as football, baseball, basketball, golf, hockey, soccer, racing or motorsports, concerts, entertainment events, competitive events, and the like.

### Example Real Time Locating System

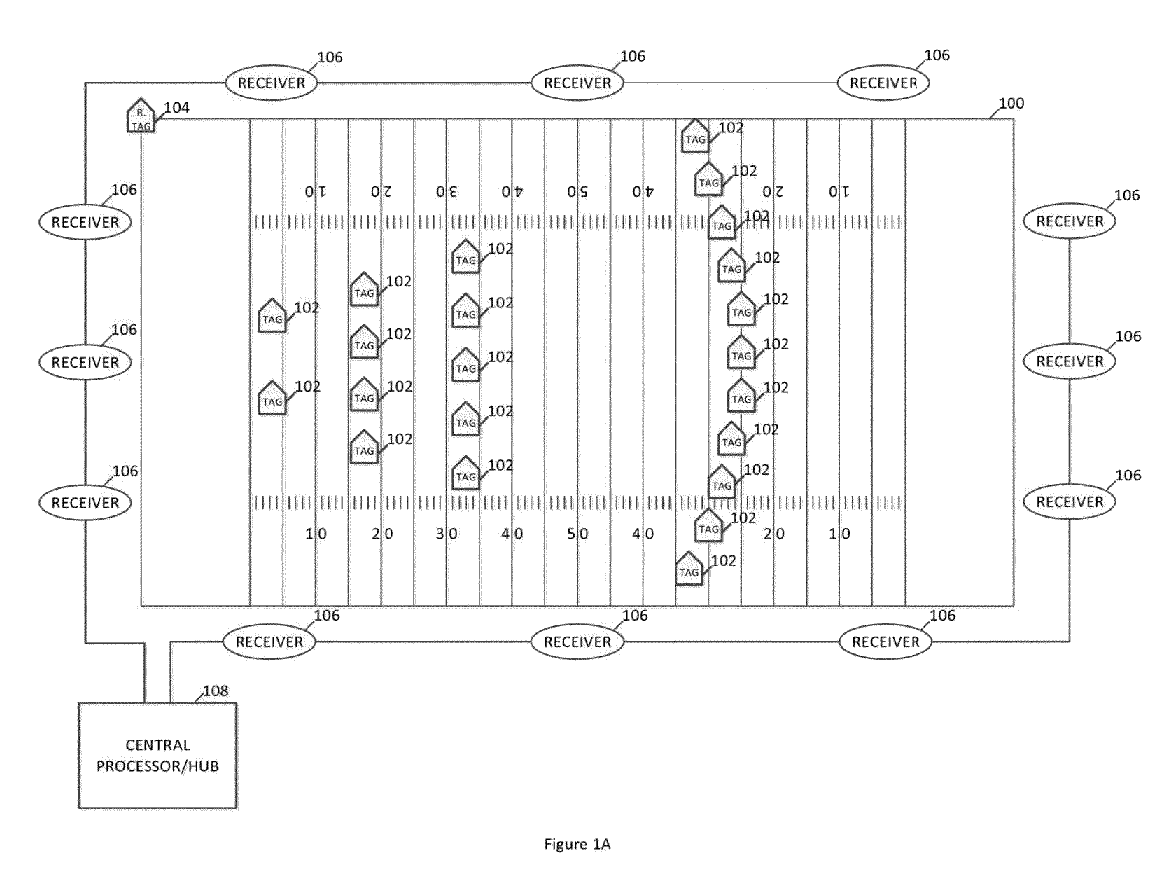

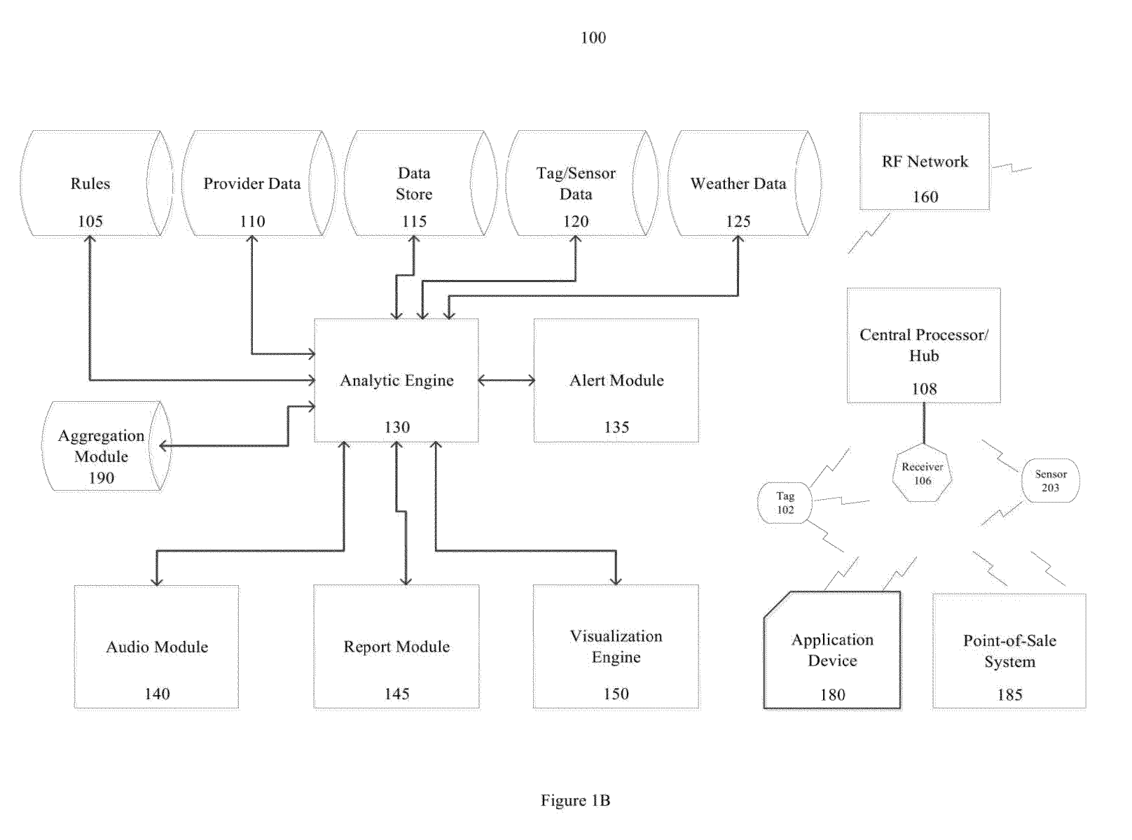

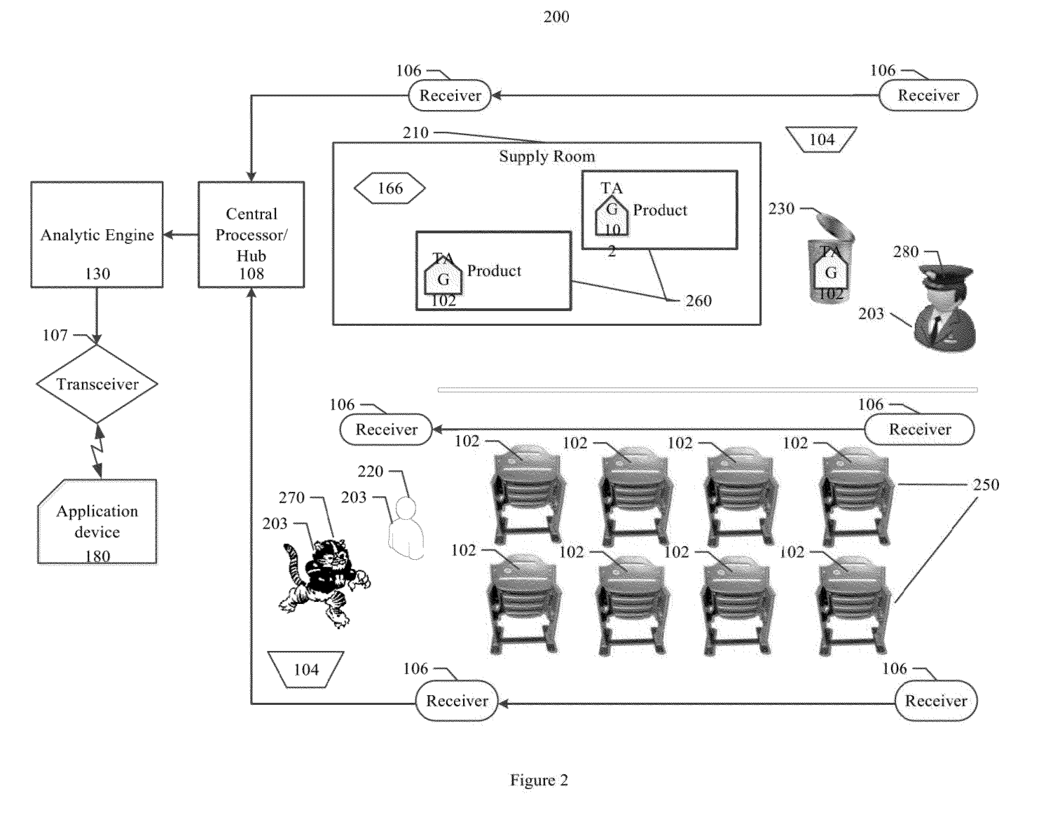

FIG. 1A illustrates an exemplary locating system 100 useful for calculating a location by an accumulation of position data or time of arrivals (TOAs) at a central processor/Hub 108, whereby the TOAs represent a relative time of flight (TOF) from RTLS tags 102 as recorded at each receiver 106 (e.g., UWB reader, etc.). A timing reference clock is used, in some examples, such that at least a subset of the receivers 106 may be synchronized in frequency, whereby the relative TOA data associated with each of the RTLS tags 102 may be registered by a counter associated with at least a subset of the receivers 106. In some examples, a reference tag 104, preferably a UWB transmitter, positioned at known coordinates, is used to determine a phase offset between the counters associated with at least a subset of the of the receivers 106. The RTLS tags 102 and the reference tags 104 reside in an active RTLS field. The systems described herein may be referred to as either “multilateration” or “geolocation” systems, terms that refer to the process of locating a signal source by solving an error minimization function of a location estimate determined by the difference in time of arrival (DTOA) between TOA signals received at multiple receivers 106.

In some examples, the system comprising at least the tags 102 and the receivers 106 is configured to provide two dimensional and/or three dimensional precision localization (e.g., subfoot resolutions), even in the presence of multipath interference, due in part to the use of short nanosecond duration pulses whose TOF can be accurately determined using detection circuitry, such as in the receivers 106, which can trigger on the leading edge of a received waveform. In some examples, this short pulse characteristic allows necessary data to be conveyed by the system at a higher peak power, but lower average power levels, than a wireless system configured for high data rate communications, yet still operate within local regulatory requirements.

In some examples, to provide a preferred performance level while complying with the overlap of regulatory restrictions (e.g. FCC and ETSI regulations), the tags 102 may operate with an instantaneous −3 dB bandwidth of approximately 400 MHz and an average transmission below 187 pulses in a 1 msec interval, provided that the packet rate is sufficiently low. In such examples, the predicted maximum range of the system, operating with a center frequency of 6.55 GHz, is roughly 200 meters in instances in which a 12 dBi directional antenna is used at the receiver, but the projected range will depend, in other examples, upon receiver antenna gain. Alternatively or additionally, the range of the system allows for one or more tags 102 to be detected with one or more receivers positioned throughout a football stadium used in a professional football context. Such a configuration advantageously satisfies constraints applied by regulatory bodies related to peak and average power densities (e.g., effective isotropic radiated power density (“EIRP”)), while still optimizing system performance related to range and interference. In further examples, tag transmissions with a −3 dB bandwidth of approximately 400 MHz yields, in some examples, an instantaneous pulse width of roughly 2 nanoseconds that enables a location resolution to better than 30 centimeters.

Referring again to FIG. 1A, the object to be located has an attached tag 102, preferably a tag having a UWB transmitter, that transmits a burst (e.g., multiple pulses at a 1 Mb/s burst rate, such as 112 bits of On-Off keying (OOK) at a rate of 1 Mb/s), and optionally, a burst comprising an information packet utilizing OOK that may include, but is not limited to, ID information, a sequential burst count or other desired information for object or personnel identification, inventory control, etc. In some examples, the sequential burst count (e.g., a packet sequence number) from each tag 102 may be advantageously provided in order to permit, at a Central Processor/Hub 108, correlation of TOA measurement data from various receivers 106.

In some examples, the tag 102 may employ UWB waveforms (e.g., low data rate waveforms) to achieve extremely fine resolution because of their extremely short pulse (i.e., sub-nanosecond to nanosecond, such as a 2 nsec (1 nsec up and 1 nsec down)) durations. As such, the information packet may be of a short length (e.g. 112 bits of OOK at a rate of 1 Mb/sec, in some example embodiments), that advantageously enables a higher packet rate. If each information packet is unique, a higher packet rate results in a higher data rate; if each information packet is transmitted repeatedly, the higher packet rate results in a higher packet repetition rate. In some examples, higher packet repetition rate (e.g., 12 Hz) and/or higher data rates (e.g., 1 Mb/sec, 2 Mb/sec or the like) for each tag may result in larger datasets for filtering to achieve a more accurate location estimate. Alternatively or additionally, in some examples, the shorter length of the information packets, in conjunction with other packet rate, data rates and other system requirements, may also result in a longer battery life (e.g., 7 years battery life at a transmission rate of 1 Hz with a 300 mAh cell, in some present embodiments).

Tag signals may be received at a receiver directly from RTLS tags, or may be received after being reflected en route. Reflected signals travel a longer path from the RTLS tag to the receiver than would a direct signal, and are thus received later than the corresponding direct signal. This delay is known as an echo delay or multipath delay. If reflected signals are sufficiently strong enough to be detected by the receiver, they can corrupt a data transmission through inter-symbol interference. In some examples, the tag 102 may employ UWB waveforms to achieve extremely fine resolution because of their extremely short pulse (e.g., 2 nsec) durations. Furthermore, signals may comprise short information packets (e.g., 112 bits of OOK) at a somewhat high burst data rate (1 Mb/sec, in some example embodiments), that advantageously enable packet durations to be brief (e.g. 112 microsec) while allowing inter-pulse times (e.g., 998 nsec) sufficiently longer than expected echo delays, avoiding data corruption.

Reflected signals can be expected to become weaker as delay increases due to more reflections and the longer distances traveled. Thus, beyond some value of inter-pulse time (e.g., 998 nsec), corresponding to some path length difference (e.g., 299.4 m.), there will be no advantage to further increases in inter-pulse time (and, hence lowering of burst data rate) for any given level of transmit power. In this manner, minimization of packet duration allows the battery life of a tag to be maximized, since its digital circuitry need only be active for a brief time. It will be understood that different environments can have different expected echo delays, so that different burst data rates and, hence, packet durations, may be appropriate in different situations depending on the environment.

Minimization of the packet duration also allows a tag to transmit more packets in a given time period, although in practice, regulatory average EIRP limits may often provide an overriding constraint. However, brief packet duration also reduces the likelihood of packets from multiple tags overlapping in time, causing a data collision. Thus, minimal packet duration allows multiple tags to transmit a higher aggregate number of packets per second, allowing for the largest number of tags to be tracked, or a given number of tags to be tracked at the highest rate.

In one non-limiting example, a data packet length of 112 bits (e.g., OOK encoded), transmitted at a data rate of 1 Mb/sec (1 MHz), may be implemented with a transmit tag repetition rate of 1 transmission per second (1 TX/sec). Such an implementation may accommodate a battery life of up to seven years, wherein the battery itself may be, for example, a compact, 3-volt coin cell of the series no. BR2335 (Rayovac), with a battery charge rating of 300 mAhr. An alternate implementation may be a generic compact, 3-volt coin cell, series no. CR2032, with a battery charge rating of 220 mAhr, whereby the latter generic coin cell, as can be appreciated, may provide for a shorter battery life.

Alternatively or additionally, some applications may require higher transmit tag repetition rates to track a dynamic environment. In some examples, the transmit tag repetition rate may be 12 transmissions per second (12 TX/sec). In such applications, it can be further appreciated that the battery life may be shorter.

The high burst data transmission rate (e.g., 1 MHz), coupled with the short data packet length (e.g., 112 bits) and the relatively low repetition rates (e.g., 1 TX/sec), provide for two distinct advantages in some examples: (1) a greater number of tags may transmit independently from the field of tags with a lower collision probability, and/or (2) each independent tag transmit power may be increased, with proper consideration given to a battery life constraint, such that a total energy for a single data packet is less that a regulated average power for a given time interval (e.g., a 1 msec time interval for an FCC regulated transmission).

Alternatively or additionally, additional sensor or telemetry data may be transmitted from the tag to provide the receivers 106 with information about the environment and/or operating conditions of the tag. For example, the tag may transmit a temperature to the receivers 106. Such information may be valuable, for example, in a system involving perishable goods or other refrigerant requirements. In this example embodiment, the temperature may be transmitted by the tag at a lower repetition rate than that of the rest of the data packet. For example, the temperature may be transmitted from the tag to the receivers at a rate of one time per minute (e.g., 1 TX/min.), or in some examples, once every 720 times the data packet is transmitted, whereby the data packet in this example is transmitted at an example rate of 12 TX/sec.

Alternatively or additionally, the tag 102 may be programmed to intermittently transmit data to the receivers 106 in response to a signal from a magnetic command transmitter (not shown). The magnetic command transmitter may be a portable device, functioning to transmit a 125 kHz signal, in some example embodiments, with a range of approximately 15 feet or less, to one or more of the tags 102. In some examples, the tags 102 may be equipped with at least a receiver tuned to the magnetic command transmitter transmit frequency (e.g., 125 kHz) and functional antenna to facilitate reception and decoding of the signal transmitted by the magnetic command transmitter.

In some examples, one or more other tags, such as a reference tag 104, may be positioned within and/or about a monitored region. In some examples, the reference tag 104 may be configured to transmit a signal that is used to measure the relative phase (e.g., the count of free-running counters) of non-resettable counters within the receivers 106.

One or more (e.g., preferably four or more) receivers 106 are also positioned at predetermined coordinates within and/or around the monitored region. In some examples, the receivers 106 may be connected in a “daisy chain” fashion to advantageously allow for a large number of receivers 106 to be interconnected over a significant monitored region in order to reduce and simplify cabling, provide power, and/or the like. Each of the receivers 106 includes a receiver for receiving transmissions, such as UWB transmissions, and preferably, a packet decoding circuit that extracts a time of arrival (TOA) timing pulse train, transmitter ID, packet number, and/or other information that may have been encoded in the tag transmission signal (e.g., material description, personnel information, etc.) and is configured to sense signals transmitted by the tags 102 and one or more reference tags 104.

Each receiver 106 includes a time measuring circuit that measures times of arrival (TOA) of tag bursts, with respect to its internal counter. The time measuring circuit is phase-locked (e.g., phase differences do not change and therefore respective frequencies are identical) with a common digital reference clock signal distributed via cable connection from a Central Processor/Hub 108 having a central timing reference clock generator. The reference clock signal establishes a common timing reference for the receivers 106. Thus, multiple time measuring circuits of the respective receivers 106 are synchronized in frequency, but not necessarily in phase. While there typically may be a phase offset between any given pair of receivers in the receivers 106, the phase offset is readily determined through use of a reference tag 104. Alternatively or additionally, each receiver may be synchronized wirelessly via virtual synchronization without a dedicated physical timing channel.

In some example embodiments, the receivers 106 are configured to determine various attributes of the received signal. Since measurements are determined at each receiver 106, in a digital format, rather than analog in some examples, signals are transmittable to the Central Processor/Hub 108. Advantageously, because packet data and measurement results can be transferred at high speeds to a receiver memory, the receivers 106 can receive and process tag (and corresponding object) locating signals on a nearly continuous basis. As such, in some examples, the receiver memory allows for a high burst rate of tag events (i.e., information packets) to be captured.

Data cables or wireless transmissions may convey measurement data from the receivers 106 to the Central Processor/Hub 108 (e.g., the data cables may enable a transfer speed of 2 Mbps). In some examples, measurement data is transferred to the Central Processor/Hub at regular polling intervals.

As such, the Central Processor/Hub 108 determines or otherwise computes tag location (i.e., object position) by processing TOA measurements relative to multiple data packets detected by the receivers 106. In some example embodiments, the Central Processor/Hub 108 may be configured to resolve the coordinates of a tag using nonlinear optimization techniques.

In some examples, TOA measurements from multiple receivers 106 are processed by the Central Processor/Hub 108 to determine a position of the transmit tag 102 by a differential time-of-arrival (DTOA) analysis of the multiple TOAs. The DTOA analysis includes a determination of tag transmit time tₒ, whereby a time-of-flight (TOF), measured as the time elapsed from the estimated tag transmit time tₒ to the respective TOA, represents graphically the radii of spheres centered at respective receivers 106. The distance between the surfaces of the respective spheres to the estimated position coordinates (xₒ, yₒ, zₒ) of the transmit tag 102 represents the measurement error for each respective TOA, and the minimization of the sum of the squares of the TOA measurement errors from each receiver participating in the DTOA position estimate provides for both the position coordinates (xₒ, yₒ, zₒ) of the transmit tag and of that tag's transmit time tₒ.

In some examples, the system described herein may be referred to as an “over-specified” or “over-determined” system. As such, the Central Processor/Hub 108 may calculate one or more valid (i.e., most correct) positions based on a set of measurements and/or one or more incorrect (i.e., less correct) positions. For example, a position may be calculated that is impossible due the laws of physics or may be an outlier when compared to other calculated positions. As such one or more algorithms or heuristics may be applied to minimize such error.

The starting point for the minimization may be obtained by first doing an area search on a coarse grid of x, y and z over an area defined by the user and followed by a localized steepest descent search. The starting position for this algorithm is fixed, in some examples, at the mean position of all active receivers. No initial area search is needed, and optimization proceeds through the use of a Davidon-Fletcher-Powell (DFP) quasi-Newton algorithm in some examples. In other examples, a steepest descent algorithm may be used.

One such algorithm for error minimization, which may be referred to as a time error minimization algorithm, may be described in Equation 1:

$$ɛ = {\sum }_{j = 1}^{N} {[ {[ {( x - {x}_{j} )}^{2} + {( y - {y}_{j} )}^{2} + {( z - {z}_{j} )}^{2} ]}^{\frac{1}{2}} - c ( {t}_{j} - {t}_{0} ) ]}^{2} \qquad ( 1 )$$

Where N is the number of receivers, c is the speed of light, (xⱼ, yⱼ, zⱼ) are the coordinates of the j^{th} receiver, tⱼ is the arrival time at the j^{th} receiver, and tₒ is the tag transmit time. The variable tₒ represents the time of transmission. Since tₒ is not initially known, the arrival times, tⱼ, as well as tₒ, are related to a common time base, which in some examples, is derived from the arrival times. As a result, differences between the various arrival times have significance for determining position as well as tₒ.

The optimization algorithm to minimize the error ε in Equation 1 may be the Davidon-Fletcher-Powell (DFP) quasi-Newton algorithm, for example. In some examples, the optimization algorithm to minimize the error ε in Equation 1 may be a steepest descent algorithm. In each case, the algorithms may be seeded with an initial position estimate (x, y, z) that represents the two-dimensional (2D) or three-dimensional (3D) mean of the positions of the receivers 106 that participate in the tag position determination.

In some examples, the RTLS system comprises a receiver grid, whereby each of the receivers 106 in the receiver grid keeps a receiver clock that is synchronized, with an initially unknown phase offset, to the other receiver clocks. The phase offset between any receivers may be determined by use of a reference tag that is positioned at a known coordinate position (x_{T}, y_{T}, z_{T}). The phase offset serves to resolve the constant offset between counters within the various receivers 106, as described below.

In further example embodiments, a number N of receivers 106 {Rⱼ:j=1, . . . , N} are positioned at known coordinates (x_{R}_{ⱼ}, y_{R}_{ⱼ}, z_{R}_{ⱼ}), which are respectively located at distances d_{R}_{ⱼ} from a reference tag 104, such as given in Equation 2:

d_{R}_{ⱼ}=\sqrt{(x_{R}_{ⱼ}−x_{T})²+(y_{R}_{ⱼ}−yT)²+(z_{R}_{ⱼ}−z_{T})}² (2)

Each receiver Rⱼ utilizes, for example, a synchronous clock signal derived from a common frequency time base, such as a clock generator. Because the receivers are not synchronously reset, an unknown, but constant offset Oⱼ exists for each receiver's internal free running counter. The value of the constant offset Oⱼ is measured in terms of the number of fine resolution count increments (e.g., a number of nanoseconds for a one nanosecond resolution system).

The reference tag is used, in some examples, to calibrate the radio frequency locating system as follows: The reference tag emits a signal burst at an unknown time τ_{R}. Upon receiving the signal burst from the reference tag, a count N_{R}_{ⱼ} as measured at receiver Rⱼ is given in Equation 3 by:

N_{R}_{ⱼ}=βτ_{R}+Oⱼ+βd_{R}_{ⱼ}/c (3)

Where c is the speed of light and β is the number of fine resolution count increments per unit time (e.g., one per nanosecond). Similarly, each object tag Tᵢ of each object to be located transmits a signal at an unknown time τᵢ to produce a count Nᵢ_{ⱼ}, as given in Equation 4:

Nᵢ_{ⱼ}=βτᵢ+Oⱼ+βdᵢ_{ⱼ}/c (4)

at receiver Rⱼ where dᵢ_{ⱼ} the distance between the object tag Tᵢ and the receiver 106 Rⱼ. Note that τᵢ is unknown, but has the same constant value for all receivers. Based on the equalities expressed above for receivers Rⱼ and Rₖ and given the reference tag 104 information, phase offsets expressed as differential count values are determined as given in Equations 5a-b:

$$\begin{matrix}{N}_{{R}_{j}} = {N}_{{R}_{k}} = ( {O}_{j} - {O}_{k} ) + β ( \frac{{d}_{{R}_{j}}}{c} - \frac{{d}_{{R}_{k}}}{c} ) \\ Or , & ( 5 a ) \\ ( {O}_{j} - {O}_{k} ) = ( {N}_{{R}_{j}} = {N}_{{R}_{k}} ) - β ( \frac{{d}_{{R}_{j}}}{c} - \frac{{d}_{{R}_{k}}}{c} ) = {Δ}_{{j}_{k}} & ( 5 b )\end{matrix}$$

Where Δⱼₖ is constant as long as d_{R}_{ⱼ}−d_{Rk} remains constant, (which means the receivers and reference tag are fixed and there is no multipath situation) and β is the same for each receiver. Note that Δⱼ_{ₖ} is a known quantity, since N_{R}_{ⱼ}, N_{R}_{ₖ}, β, d_{R}_{ⱼ}/c, and d_{R}_{ₖ}/c are known. That is, the phase offsets between receivers Rⱼ and Rₖ may be readily determined based on the reference tag 104 transmissions. Thus, again from the above equations, for a tag 102 (Tᵢ) transmission arriving at receivers Rⱼ and Rₖ, one may deduce the following Equations 6a-b:

$$\begin{matrix}{N}_{{i}_{j}} = {N}_{{i}_{k}} = ( {O}_{j} - {O}_{k} ) + β ( \frac{{d}_{{i}_{j}}}{c} - \frac{{d}_{{i}_{k}}}{c} ) = {Δ}_{{j}_{k}} + β ( \frac{{d}_{{i}_{j}}}{c} - \frac{{d}_{{i}_{k}}}{c} ) \\ Or , & ( 6 a ) \\ {d}_{{i}_{j}} - {d}_{{i}_{k}} = ( c / β ) [ {N}_{{i}_{j}} - {N}_{{i}_{k}} - {Δ}_{{j}_{k}} ] & ( 6 b )\end{matrix}$$

Each arrival time, tⱼ, can be referenced to a particular receiver (receiver “1”) as given in Equation 7:

$${t}_{j} = \frac{1}{β} ( {N}_{j} - {Δ}_{j 1} ) \qquad ( 7 )$$

The minimization, described in Equation 1, may then be performed over variables (x, y, z, tₒ) to reach a solution (x′, y′, z′, tₒ′).

### Example Provider Supply and Demand-Distribution and Tracking

FIG. 1B illustrates an exemplary location system 100 for providing analytic distribution and tracking in accordance with some embodiments of the present invention. The depicted location system 100 may be distributed via central processor/hub 108 and receiver 106. Central processor/hub 108 determines or computes tag location (i.e., provider location) by processing TDOA measurements related to multiple data packets detected by receiver 106. In some example embodiments, central processor/hub 108 may be configured to resolve the coordinates of a tag using nonlinear optimization techniques. In alternative embodiments, location system 100 may be housed or located in a single housing or unit. In still other embodiments, location system 100 may be distributed among multiple additional housings or units depending upon the application and other design parameters that will be apparent to one of ordinary skill in the art in view of this disclosure.

The location system 100 of FIG. 1B may include analytic engine 130, alert module 135, audio module 140, report module 145, visualization engine 150, a plurality of databases, a plurality of output systems, a plurality of tags 102, optional sensors 203 associated with providers, a plurality of receivers 106 positioned within a monitored area, central processor/hub 108, RF network 160, and/or the like.

In an exemplary location system 100, such as illustrated in FIG. 1B, the plurality of tags 102 (and sensors 203) may be attached to a provider, monitored individual, and/or the like. In some embodiments, the plurality of tags 102 and/or sensors 203 may be activated and deactivated as needed, such as before and after an experience, event, and/or the like. Receiver 106 may receive blink data transmitted via a signal by tag 102. The blink data may include a tag unique identifier. In some embodiments, receivers 106 may be configured with appropriate RF filters, such as to filter out potentially interfering signals or reflections proximate a monitored area. Central processor/hub 108 may be configured to calculate tag location data. In some embodiments, central processor/hub 108 may be further configured to correlate tag location data to provider location data.

The analytic engine 130 uses a real time tag location data stream from central processor/hub 108, as well as provider data 110 to provide accurate information about what a particular provider and/or monitored individual is doing in real time (or near real time). Analytics engine 130 may further use other tag and sensor derived data, received from central processor/hub 108, to aid in determining supply and demand as it relates to one or more providers and/or monitored individuals, for example, where the provider is, how that provider's location is changing with time, velocity, acceleration, deceleration, orientation, or the like. Analytics engine 130 outputs multi-dimensional provider location information per unit time (e.g., provider location data).

Aggregation module 190 may be configured to aggregate demand using a defined hierarchy or taxonomy that relates the one or more providers, monitored individuals, monitored areas, products, services, or experiences, for example, into at least one of a category, sub-category, meta-category, and/or the like.

In order to ascertain demand by location, analytic engine 130 may be configured to correlate, using processor 305, the demand to tag location data and/or provider location data received via tag/sensor database 120. In some embodiments, analytic engine 130 may generate experience enhancement data based on the demand correlated to the tag location data and the provider location data. For example, analytic engine 130 may generate experience enhancement data that defines and/or optimizes sales trends based, in part, on the location of the provider and/or data generated at the point of sale via payment system 185. In other example embodiments, the location system described herein may use experience enhancement data to illustrate that when a provider, such as Beer Vendor A, sells beer in Concourse A that provider's sales volume doubles when compared to the sales volume achieved selling beer in Concourse B.

The analytic engine 130 may programmatically utilize machine learning to develop a particular pattern recognition algorithm based on statistical inferences. Such machine learning may be unsupervised (e.g., determining a hidden structure from unlabeled data) or supervised (e.g., inferring a function from a set of training patterns with each training pattern placed into a classifier which can be used to map new data). The algorithm may determine the classification of new data based, in part, on such learned training patterns.

In some example embodiments, a patron operated application device 180 (e.g., a smart phone carried by a patron) may be correlated to a tag 102. The interface of the application device may be operate via WiFi, Bluetooth, NFC, QR, barcodes and/or the like. One or more receivers 106 may receive transmissions from the tag 102 correlated to the patron operated application device 180 and transmit the blink data to a central processor/hub 108. The central processor/hub 108 may process the received data to determine the tag location. The central processor/hub 108 may transmit the tag location data to one or more processors, such as an analytic engine 130. The analytic engine 130 may use one or more modules (e.g., processing engines) and one or more databases to identify the patron operated application device and, thereby, identify each patron associated with each tag 102. Further, the tag location of the patron operated application device and/or sales data may be transmitted to the analytic engine 130. The analytic engine 130 may programmatically utilize machine learning to develop a particular pattern recognition algorithm based on statistical inferences that includes point of sale data and tag location data correlated to patron operated application devices 180, provider location tags, payment systems, and/or the like.

Yet, in other example embodiments, a patron may complete a survey prior to the event. The survey may be correlated to the patron's ticket, products, and/or the like. In other example embodiments, a patron may execute a purchase prior to the event and such purchase may be correlated to a patron's ticket. The analytic engine 130 may utilize a pattern recognition algorithm based on statistical inferences to map new data based on such correlated data that may include products and/or offerings a patron may be likely to purchase, participate in, utilize, and/or the like.

In yet another example, experience enhancement data may provide analytic data based on one or more factors, such as the weather (e.g., the temperature data as indicated by sensor 203), experience (e.g., a football game), monitored area, time of day, etc. For example, when the weather is below 70 degrees Fahrenheit in the shaded area of the venue during an early evening game, coffee sales increase, while ice cream sales decrease. In yet another example, analytic data generated by analytic engine 130 may optimize Beer Vendor A's route(s) based on historical data, sale points generated via payment system 185, and/or tag location data demonstrating Beer Vendor A's revenue received and/or product sold in a monitored area. Further analytic engine 130 may be configured to store the aggregated demand in, for example, aggregation module 190, Memory 320, and/or the like.

In some embodiments, location system 100 may be configured to utilize, using processor 305, the experience enhancement data to generate analytic data via analytic engine 130. The analytic data may include at least one of provider data, monitored individual data, transaction data, experience data, and/or the like. Location system 100 may be further configured to calculate provider supply via analytic engine 130 from data received from data store 115, provider data 110, tag/sensor database 120, weather data 125, and/or aggregation module 190. The provider supply may be allocated, distributed, reallocated and/or the like based on the demand. For example, if the temperature decreases during a football game, analytic engine 130 may determine a decrease in sells for frozen cappuccinos in Section 100. Alert module 135 may generate an alert to inform Café Vendor A of the provider's short-term need to sell coffee or hot chocolate.

In further examples, such provider supply may be optimized at re-supply points as determined by analytic engine 130. Analytic engine 130 may determine the most profitable re-supply points based on the tag location data, sensor position data, and/or the like received from central processor/hub 108. Analytic engine 130 may utilize a pattern recognition algorithm to determine re-supply points. For example, analytic engine 130 may determine the revenue lost when a provider leaves the aisle to re-stock the supply.

Analytic engine 130 may be configured to generate, using processor 305, historical analytic data and/or predictive analytic data. The historical analytic data and/or the predictive analytic data may be based, in part, on at least one of the tag location data, provider location data, and/or monitored individual location data. Such data may be transmitted via blink data from tag 102 to receiver 106. Central processor/hub 108 may receive such data from receiver 106. In some embodiments, such data is transmitted from central processor/hub 108 to analytics engine 130. Yet, in other embodiments, the historical analytic data and/or the predictive analytic data may include at least one of weather data, provider data, demographic data, monitored area data, or periodic data. For example, analytic engine 130 may generate historical analytic data that illustrates over the past five years in the month of August there has been an increase in sales for peanuts when the price of beer is less than $5.00 and the temperature in a monitored area is greater than 80 degrees Fahrenheit.

In further examples, analytic engine 130 may generate predictive analytic data that predicts a reduction in the number of food vendors required for a monitored area on a particular day based on the amount of pre-purchased food packages. Further, analytic engine 130 may be configured to store the historical analytic data and/or the predictive analytic data in, for example, aggregation module 190, Memory 320, and/or the like.

In order to facilitate communication within location system 100, in some example embodiments, alert module 135 may be configured to generate, using processor 305, an alert based on at least one of tag location data, provider location data, provider supply, analytic data, or demand. The alert may include at least one of a text message, a promotion, an email, an invitation, a message, or a notification. The alert may be transmitted to application device 180 and/or to one or more systems. Further Communication Interface 315 may output the alert. For example, alert module 135 may generate an alert in the form of a text message to application device 180 (e.g., a smart phone carried by a patron) when Hot Dog Provider A has unsold hot dogs at the top of third quarter.

In other examples, alert module 135 may be configured to generate an alert, using processor 305, to patrons, providers, or the like that includes a message to evacuate the venue based on tag location data, one or more rules, sensor position data, or the like associated with a monitored area. In another example embodiment, the alert module may generate an alert to application device 180 held by Employee A. The alert may include a message to notify Employee A to take in-aisle inventory to Employee B. Such alerts aid in increasing sales efficiency, optimizing sells revenue, and reducing re-stocking inefficiencies.

In further examples, such data generated by analytic engine 130 may be utilized to allocate one or more providers to a monitored area based on an event, periodic data, predictive analytic data, and/or the like. An event may include an occurrence that requires use of providers, for example, emergency personnel, security personnel, personalities, and/or the like. In some example embodiments, an event may also include an occurrence such as a medical and/or security situation. For example, analytic engine 130 may determine a demand for alcohol in Section 100 meets and/or exceeds a threshold based on the alcohol sales data and patron density as identified via sensor position data and/or tag location data. Analytic engine 130 may generate predictive analytic data predicting the need for additional security personnel in Section 100. The additional security personnel may be allocated to Section 100 to prevent previous issues as determined by historical analytic data generated by analytic engine 130, using processor 305, or predictive analytic data generated by analytic engine 130 that relates to alcohol consumption.

For example, sensors 203 may transmit sensor position data to tag 102 as the patron density changes within a monitored area. Tag 102 may transmit the tag location data and/or sensor position data to central processor/hub 108. Central processor/hub 108 may transmit the patron density data to analytic engine 130. Upon receiving such data, analytic engine 130 may programmatically determine disturbance (e.g. a fight) trends based on patron density and alcohol sales. The analytic engine 130 may allocate additional security to a monitored area based on the result disturbance trends.

In some embodiments, analytic engine 130 may be configured to provide for event indications in real time (or near real time). Such event indications may be transmitted via tag 102 that includes a tag unique identifier to verify the event. In other embodiments, analytic engine 130 may configured to generate event indications via one or more buttons, links, icons, and/or the like to verify performance of an event. For example, a provider of cleaning services may press an event button when a restroom has been serviced or when a garbage can has been serviced. The pressing of an event button sends provider location data to location system 100.

In other examples, a provider of entertainment services may press an event button to dispatch emergency personnel. Such indications may be output to a variety of systems including, without limitation, visualization engine 150, alert module 135, a camera control system, a statistics system, etc.

In another embodiment, analytic engine 130 may be configured to calculate a location summary based on at least one of sensor position data or tag location data. In other embodiments, visualization engine 150 may be configured to output analytic data generated by the analytics engine based on the location summary correlated to at least one of sensor position data or tag location data transmitted to the analytics engine 130 via central processor/hub 108. In an example embodiment, visualization engine 150 may output the analytic data in the form of a heat map or any diagram showing a relation between variable quantities. For example, analytic engine 130 may calculate a location summary based on the sensor position data for each popcorn vendor proximate a monitored area. Visualization engine 150 may generate a heat map to depict the location of each popcorn vendor proximate the monitored area. In further examples, analytic engine 130 may calculate a location summary based on the sensor position data for each mascot proximate a monitored area and visualization engine 150 may generate a diagram to depict the relation between one or more mascots.

In other examples, visualization engine 150 may depict the location of reported incidents, issues, and/or the like. Visualization engine 150 may be further configured to depict periodic data based on at least one of tag location data or sensor position data. For example, visualization engine 150 may illustrate periodic data, such as the response time, time of arrival, time of departure, duration of stay, etc., of each medical personnel located within Concourse A based on sensor position data calculated by analytic engine 130.

In other examples, visualization engine 150 may be configured to generate, using processor 305, a diagram that analyzes transaction data. For example, visualization engine 150 may generate a diagram illustrating top performing sales, products, services, etc. In further embodiments, visualization engine 150 may generate a diagram that analyzes aggregated data received from aggregation module 190. For example, a graph illustrating top food sales having a category “food,” a sub-category, “type of food,” a meta-category “food item,” etc.

Further, in other embodiments, a location system, such as location system 100, may track the tag, tag location data, provider location data, mobile provider location data, sensor position data, and/or the like. In another example embodiment, central processor/hub 108 may track tag 102 and/or sensor 203 correlated to a provider, such as an object. For example, central processor/hub 108 may track a case of nuts, cart, or merchandise. In some embodiments, analytic engine 130 may track providers, such as objects, to determine inventory. Transaction data associated with tag location data, sensor position data, and or monitored area data, for example an aisle, may be tracked to generate predictive analytic data such as the supply required for future games and/or group activities.

In other examples, central processor/hub 108 may be configured to track, using processor 305, the expiration of a provider, for example a product, via a tag and/or periodic data. Such tracking may be utilized to assist in product recalls and investigations which may reduce liability. Further, central processor/hub 108 may track providers, such as food products, utilized in “all you-can-eat” offerings, packages, promotions, and/or the like. In example embodiments, central processor/hub 108 may track a particular beverage by a barcode, tag location data, sensor position data, and/or the like and further determine when the product or service may be used. For example, analytic engine 130 may enforce a lock-out period for a self-serviced beverage. During the lock-out period, the container with the attached bar code may not be re-filled.

In some embodiments, central processor/hub 108 may be further configured to track, one or more providers simultaneously. For example, analytic engine 130 may track the locations of multiple mascots. In some embodiments, the alert module may generate an alert when identical mascots are within (or near) the same monitored area. In an example embodiment, the analytics engine may track provider location data as such data correlates to a monitored area. For example, analytic engine 130 may track the monitored areas visited by the mascot.

Analytic engine 130 may also be configured to analyze, using processor 305, periodic data and one or more rules correlated to provider location data, tag location data, and/or sensor position data. For example, analytic engine 130 may track a provider's, such as a mascot, service time and contract rules as correlated to the mascot's location in a monitored area.

In other embodiments, central processor/hub 108 may be configured to include tags 102 which may be configured as a mobile provider tag. Central processor/hub 108 may be configured to calculate mobile provider tag location data based in part on blink data from the mobile provider tag. In other embodiments, mobile provider location data may be tracked to determine the locations of each of the mobile providers proximate the venue. For example, central processor/hub 108 may track the location of sensor position data correlated to a mobile provider (e.g. a cotton candy tray). Central processor/hub 108 may further track the location of tag 102 and/or sensor 203 correlated to the vendor carrying the tray of cotton candy. Analytic engine 130 may output tracked data received from central processor/hub 108 to report module 145, alert module 135, application device 180, one or more databases, and/or the like. Further, analytic engine 130 may be configured to store the tracked data from tag 102 and/or sensor position data 203 in, for example, analytic engine 130, provider data 110, data store 115, tag/sensor database 120, Memory 320, and/or the like.

In other embodiments, audio module 140 may be configured to receive an audio event correlated to the tag location data and provider location data. Audio module 140 may be further configured to output the audio event to alert module 140, application device 180, analytic engine 130, and/or the like. For example, a mascot may speak a request for emergency services into an audio receiver, such as a microphone. The audio module 140 may receive the request for emergency services as the tag location data correlated to the mascot may be transmitted to the receiver 106. Upon receipt of the request for emergency services, the central processor/hub 108 may transmit the request to analytics engine 130. Audio module 140 may be further configured to output the request for emergency services to application device 180 (e.g., an application device carried by security personnel) or alert module 140.

### Example RF Location System-Provider Environment

FIG. 2 illustrates a radio frequency location system useful for determining the location of a provider (e.g. employees, vendors, merchants, personalities, etc.) by determining RF location tag 102 (e.g., a ultra-wide band (UWB) location tag) location information at each receiver 106 (e.g., UWB reader, etc.).

The exemplary radio frequency location system of FIG. 2 may be used in providing analytics in accordance with some embodiments of the present invention. In the environment of FIG. 2, data may be captured and analyzed, such as during a sporting event to identify events, statistics, and other data useful to venue owners, operations management, vendors, emergency personnel, or the like. In some embodiments, data associated with a number of monitored individuals in a venue, such as monitored area 200, may be generated and provided to analytic engine 130. As such, each monitored individual, for example a provider here depicted in the form of objects (e.g. garbage can 230, seat 250, product 260), may have one or more attached tags 102 to be used to track data such as location, change of location, speed, product expiration, receipt of service, or the like. In some embodiments, additional sensors, such as, without limitation, accelerometers, magnetometers, health sensors, temperature sensors, moisture sensors, light sensors, or the like, may be attached to each object to provide further data to analytic engine 130. Such additional sensors may provide data to tag 102, either through a wired or wireless connection, to be transmitted to receivers 106 or sensors 203 which may be configured to transmit data to receivers (i.e., sensor receivers) separately from tags 102.

One or more of receivers 106 may receive transmissions from tags 102 and transmit the blink data to central processor/hub 108. Central processor/hub 108 may process the received data to determine tag location for tags 102. Central processor/hub 108 may transmit the tag location data to one or more processors, such as analytic engine 130. Analytic engine 130 may use one or more modules (e.g., processing engines) and one or more databases to identify the monitored individual each of tags 102 is associated with, such as vendor 220, mascot 270, product 260, security personnel 280, or the like.

In some embodiments, tags 102 (as well as other sensors) may be attached to the equipment worn by a provider (e.g. vendor, mascot, VIP assistant, or the like), patron, and/or the like. The analytic engine 130 may use one or more databases to associate the tag identifier (e.g., a tag UID) of each tag 102 to each monitored individual and correlate the tag location data and/or other tag and sensor derived data for tags 102 that are associated with a particular monitored individual.

Analytic engine 130 may then use the tag location data and/or other tag and sensor derived data to determine monitored individual data, such as how the provider's location is changing with time, orientation, velocity, acceleration, deceleration, or the like. Analytic engine 130 may also use the data and one or more databases to generate, for example, analytic data, such as by aggregating the data to determine supply and demand, sales trends, etc. Analytic engine 130 may also use the data to provide statistics or other output data. Furthermore, analytic engine 130 may use the data to programmatically generate trends (e.g. sales trends) and other machine learning models via pattern recognition algorithms based on statistical inferences.

In some embodiments, analytic engine 130 may output analytic data to transceiver 107. Transceiver 107 may, in response, output the analytic data received from analytic engine 130 to application device 180.

### Example Processing Apparatus

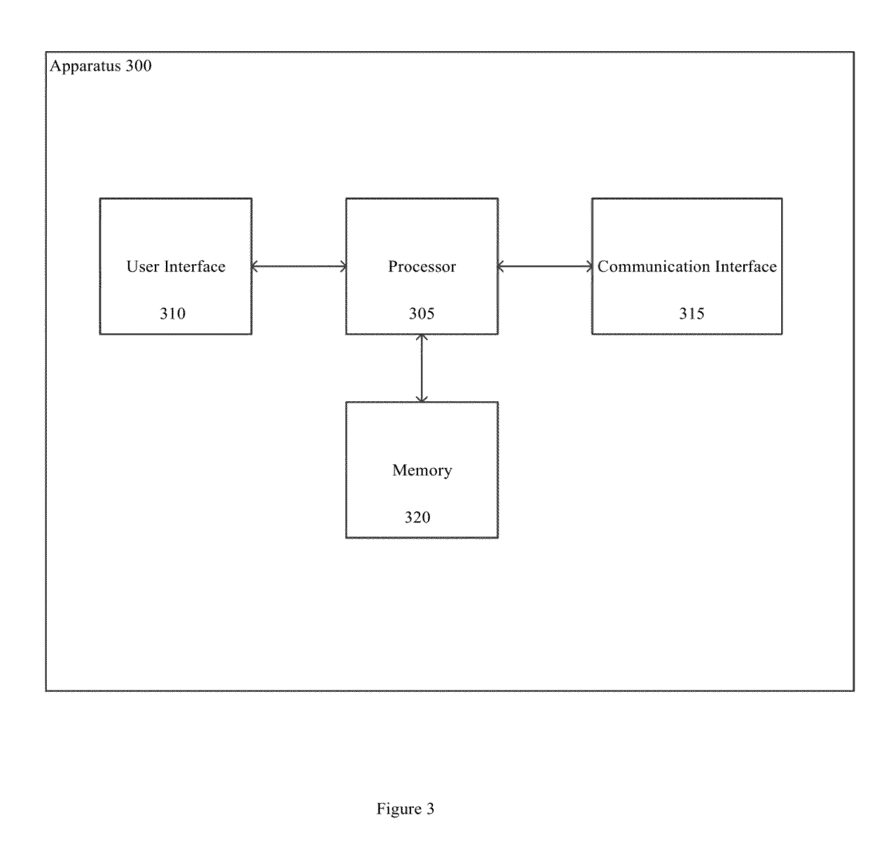

FIG. 3 shows a block diagram of components that may be included in an apparatus that may provide analytics in accordance with embodiments discussed herein. Apparatus 300 may comprise one or more processors, such as processor 305, one or more memories, such as memory 320, communication circuitry 315, and user interface 310. Processor 305 can be, for example, a microprocessor that is configured to execute software instructions and/or other types of code portions for carrying out defined steps, some of which are discussed herein. Processor 305 may communicate internally using data bus, for example, which may be used to convey data, including program instructions, between processor 305 and memory 320.

Memory 320 may include one or more non-transitory storage media such as, for example, volatile and/or non-volatile memory that may be either fixed or removable. Memory 320 may be configured to store information, data, applications, instructions or the like for enabling Apparatus 300 to carry out various functions in accordance with example embodiments of the present invention. For example, the memory could be configured to buffer input data for processing by processor 305. Additionally or alternatively, the memory could be configured to store instructions for execution by processor 305. Memory 320 can be considered primary memory and be included in, for example, RAM or other forms of volatile storage which retain its contents only during operation, and/or memory 320 may be included in non-volatile storage, such as ROM, EPROM, EEPROM, FLASH, or other types of storage that retain the memory contents independent of the power state of the Apparatus 300. Memory 320 could also be included in a secondary storage device, such as external disk storage, that stores large amounts of data. In some embodiments, the disk storage may communicate with processor 305 using an input/output component via a data bus or other routing component. The secondary memory may include a hard disk, compact disk, DVD, memory card, or any other type of mass storage type known to those skilled in the art.

In some embodiments, processor 305 may be configured to communicate with external communication networks and devices using communication circuitry 315, and may use a variety of interfaces such as data communication oriented protocols, including X.25, ISDN, DSL, among others. Communication circuitry 315 may also incorporate a modem for interfacing and communicating with a standard telephone line, an Ethernet interface, cable system, and/or any other type of communications system. Additionally, processor 305 may communicate via a wireless interface that is operatively connected to communication circuitry 315 for communicating wirelessly with other devices, using for example, one of the IEEE 802.11 protocols, 802.15 protocol (including Bluetooth, Zigbee, and others), a cellular protocol (Advanced Mobile Phone Service or “AMPS”), Personal Communication Services (PCS), or a standard 3G wireless telecommunications protocol, such as CDMA2000 lx EV-DO, GPRS, W-CDMA, LTE, and/or any other protocol.

The Apparatus 300 may include a user interface 310 that may, in turn, be in communication with the processor 305 to provide output to the user and to receive input. For example, the user interface may include a display and, in some embodiments, may also include a keyboard, a mouse, a joystick, a touch screen, touch areas, soft keys, a microphone, a speaker, or other input/output mechanisms. The processor may comprise user interface circuitry configured to control at least some functions of one or more user interface elements such as a display and, in some embodiments, a speaker, ringer, microphone and/or the like. The processor and/or user interface circuitry comprising the processor may be configured to control one or more functions of one or more user interface elements through computer program instructions (e.g., software and/or firmware) stored on a memory accessible to the processor (e.g., memory 320, and/or the like).

### Process for Ascertaining Supply and Demand by Location

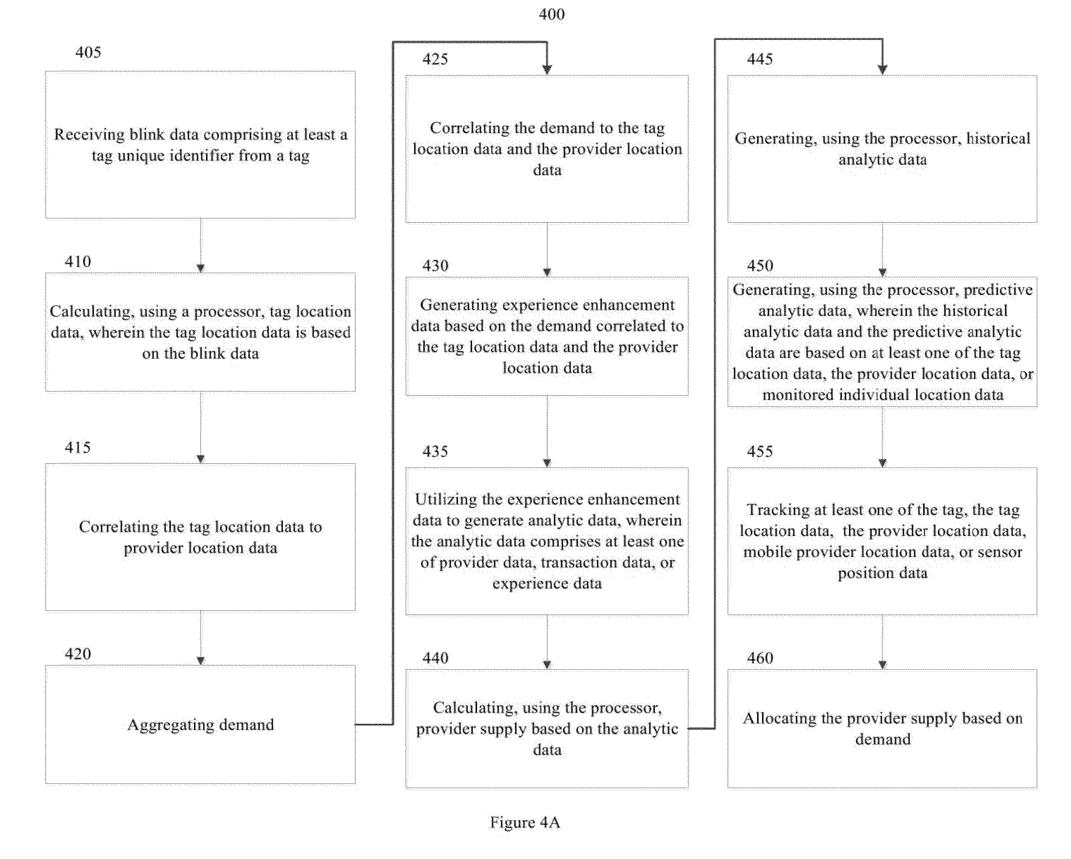

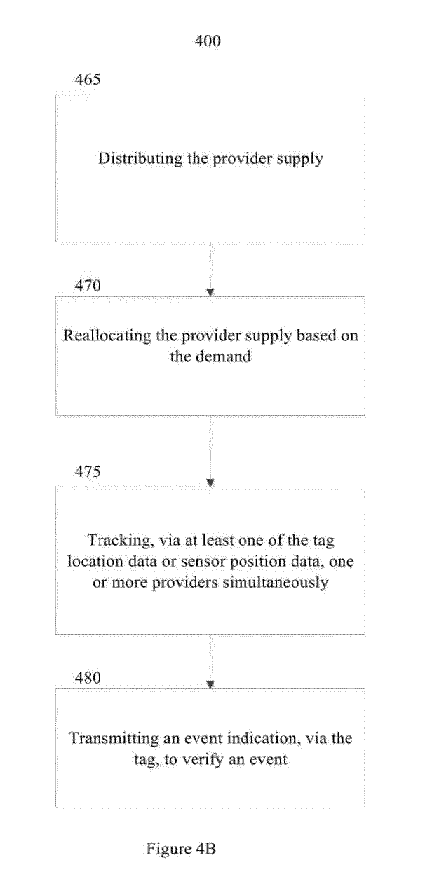

FIGS. 4A-4B illustrates an example method, namely process 400, that may be executed by one or more machines (some examples of which are discussed in connection with FIGS. 1-3) to analyze supply and demand using a location system in accordance with some embodiments of the present invention. As shown in block 405 of FIG. 4A, an apparatus such as location system 100, may include means, such as central processor/hub 108, processor 305, or the like for receiving blink data. The blink data may include at least a tag unique identifier from a tag (e.g. tag 102). As shown in block 410 of FIG. 4A, central processor/hub 108 may calculate, using a processor, for example processor 305, tag location data. The tag location data may be based on the blink data. In some embodiments, central processor/hub 108 may correlate tag location data to provider location data as shown in block 415 of FIG. 4A.

In other embodiments, as shown in block 420 of FIG. 4A, location system 100 may include means, such as aggregation module 190, processor 305, or the like for aggregating demand. Demand may be aggregated using a defined hierarchy or taxonomy that relates one or more providers, monitored areas, products, services, or experiences, for example, into at least one of a category, sub-category, meta-category, and/or the like. In some embodiments, experience enhancement data generated by analytic engine 130 may provide data based on one or more factors, such as the weather, experience, monitored area, time of day, etc. For example, when the weather is below 70 degrees Fahrenheit in the shaded area of the venue during an early evening game, coffee sales increase, while ice cream sales decrease.

As shown in block 425 of FIG. 4A, location system 100 may include means, such as analytic engine 130, processor 305, or the like to correlate the demand to tag location data and/or provider location data received via central processor/hub 108 and/or tag/sensor database 120. In some embodiments, analytic engine 130 may generate experience enhancement data based on the demand correlated to the tag location data and the provider location data as shown in block 430. For example, analytic engine 130 may generate experience enhancement data as informed by pattern recognition algorithms that define and/or optimize sales trends based, in part, on the location of the provider and/or the point of sale. For example, location system 100 described herein may use experience enhancement data informed by a pattern recognition algorithm to illustrate that when a provider, such as Beer Vendor A, sells beer in Concourse A that provider's sales volume doubles when compared to the sales volume achieved selling beer in Concourse B.

As shown in block 435 of FIG. 4A, location system 100 may include means, such as analytic engine 130, processor 305, or the like for utilizing the experience enhancement data to generate analytic data. The analytic data may include at least one of provider data, transaction data, experience data, and/or the like.

At block 440 of FIG. 4A, location system 100 may include means, such as analytic engine 130, processor 305, or the like for calculating provider supply received from data store 115, provider data 110, weather data 125, and/or aggregation module 190. The provider supply may be allocated, distributed, reallocated and/or the like based on the demand. For example, if the temperature decreases during a football game, analytic engine 130 may determine a decrease in sells for frozen cappuccinos in Section 100 and may inform Café Vendor A of the provider's short-term need to sell coffee or hot chocolate. In further examples, analytic engine 130 may optimize provider supply at re-supply points. For example, analytic engine 130 may determine the revenue lost when a provider re-stocks the supply.

As shown in block 445 of FIG. 4A, location system 100 may include means, such as analytic engine 130, processor 305, or the like for generating historical analytic data and/or predictive analytic data. The historical analytic data and/or the predictive analytic data may be based, in part, on at least one of the tag location data or the provider location data from tag/sensor database 120 as shown in block 450 of FIG. 4A. In some embodiments, the historical analytic data and/or the predictive analytic data may include at least one of weather data, provider data, demographic data, monitored area data, or periodic data. For example, analytic engine 130 may generate historical analytic data that shows peanut sales during the past five years in the month of August increase when the temperature in a monitored area is greater than 80 degrees Fahrenheit.

At block 455 of FIG. 4A, location system 100 may include means, such as central processor/hub 108, processor 305, or the like for tracking at least one of the tag location data or sensor position data, or one or more providers simultaneously as shown at block 475 of FIG. 4B. For example analytic engine 130 may track the locations of identical mascots.

As shown at block 480, location system 100 may include means, such as tag 102, for transmitting an event indication to verify an event. In some embodiments, event indications may be transmitted in real time (or near real time) to verify the performance of the event. In other embodiments, location system 100 may include means such as tag 102 to generate event indications via one or more buttons, links, icons, and/or the like to verify provider performance and/or event indications. For example, a provider of cleaning services may press an event button (e.g. a button entitled “Maintenance Complete”) when a restroom has been serviced. In other examples, a provider of entertainment services may press an event button (e.g. a “Panic” button) to dispatch emergency personnel.

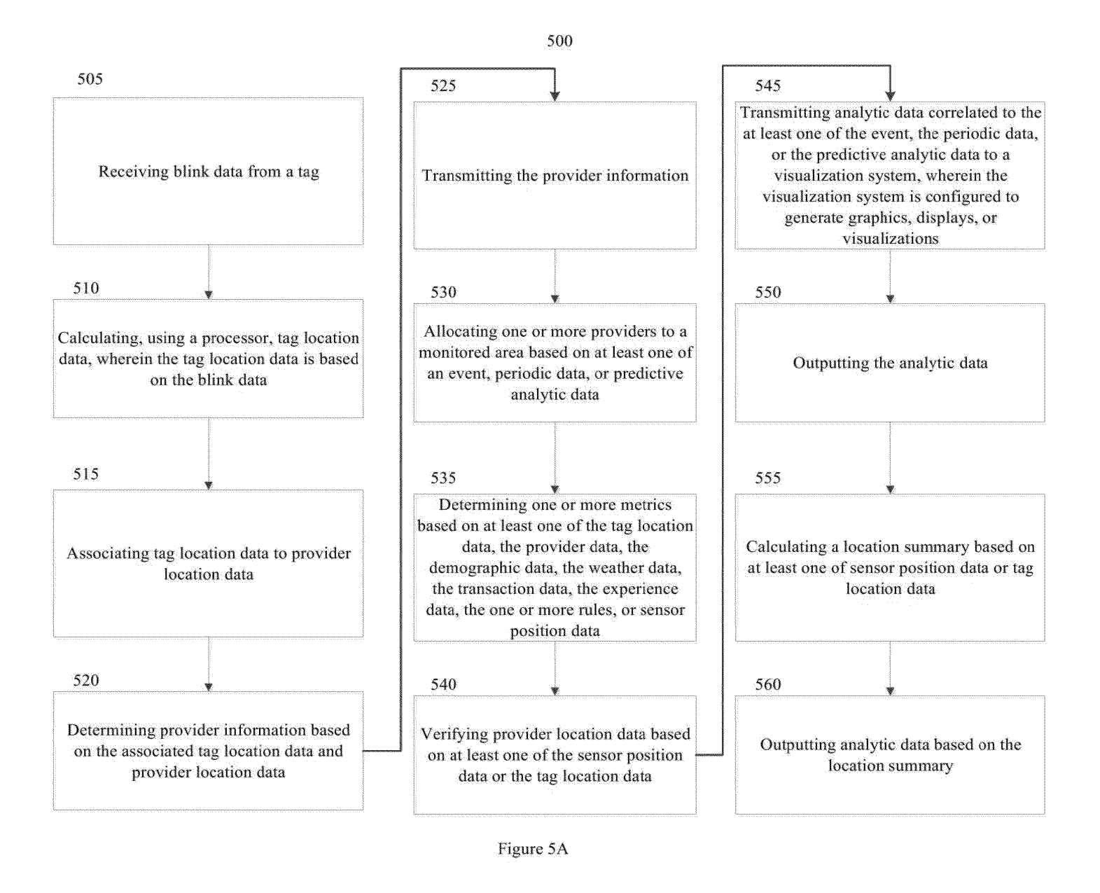

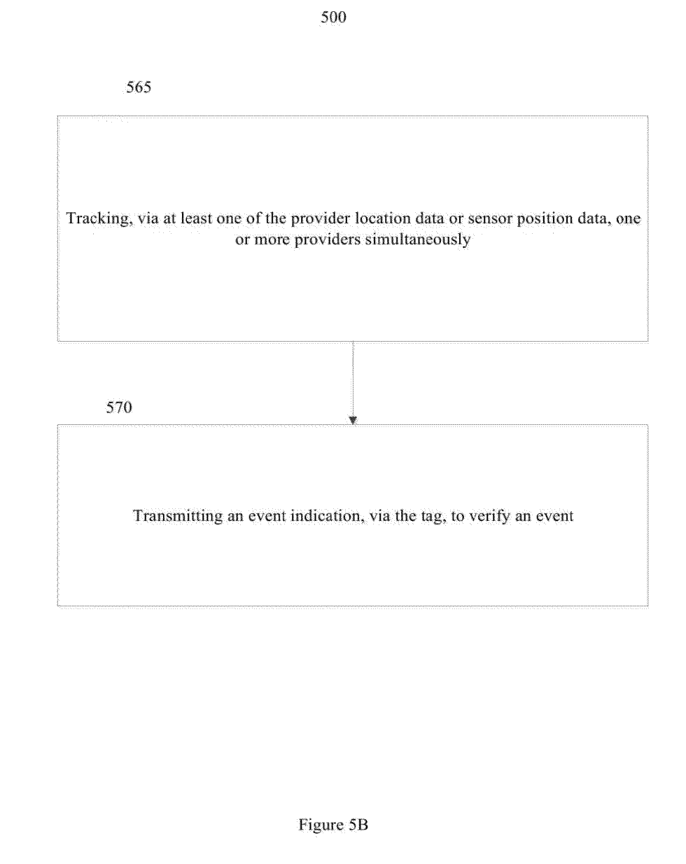

FIGS. 5A-5B show an example method, namely process 500, that may be executed by one or more machines (some examples of which are discussed in connection with FIGS. 1-3) to analyze supply and demand using a location system in accordance with some embodiments of the present invention. As shown in block 505 of FIG. 5A, an apparatus such as location system 100, may include means, such as central processor/hub 108, processor 305, or the like for receiving blink data from a tag, such as tag 102. As shown in block 510 of FIG. 5A, central processor/hub 108 may calculate, using a processor, for example processor 305, tag location data. The tag location data may be based on the blink data. In some embodiments, central processor/hub 108 may associate tag location data to provider location data as shown in block 515 of FIG. 5A.

To ascertain provider information, as shown in block 520 of FIG. 5A, location system 100 may include means, such as central processor/hub 108, analytic engine 130, processor 305, or the like for determining provider information. In some embodiments, the determined provider information may be based on the associated tag location data, provider location data, and/or the like transmitted via central processor/hub 108. At block 525 of FIG. 5A, the location system may transmit the provider information. The provider information may be transmitted to alert module 135, visualization engine 150, report module 145, application device 180, payment system 185, and/or the like. For example, central processor/hub 108 may determine the nearest security personnel may be security guard X located in a monitored area, such as Concourse C.

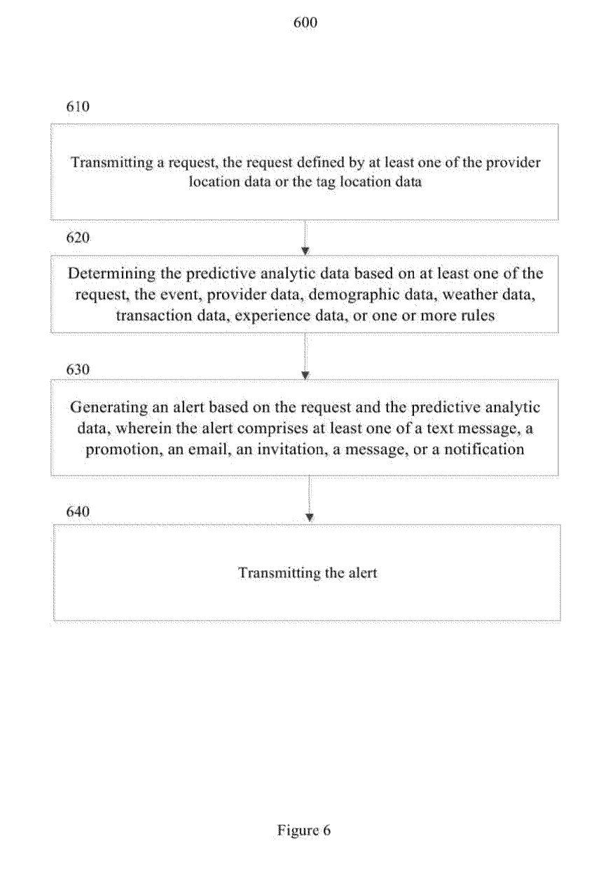

As shown in block 530 of FIG. 5A location system 100 may include means, such as analytic engine 130, processor 305, or the like for allocating one or more providers to a monitored area based on at least one of an event, periodic data, predictive analytic data, and/or the like. FIG. 6 as described herein below further illustrates block 530 of FIG. 5A.

At block 535 of FIG. 5A, location system 100 may include means, such as analytic engine 130 to determine one or more metrics. The metrics may be based on at least one of, tag location data, provider data, demographic data, weather data, transaction data, experience data, periodic data, one or more rules, sensor position data, and/or the like. For example, analytic engine 130 may determine performance metrics correlated to Popcorn Vendor X.

As shown at block 540 of FIG. 5A location system 100 may include means, such as central processor/hub 108, processor 305, or the like for verifying provider location data based on at least one of sensor position data, tag location data, and/or the like. For example, a provider of cleaning services may press an event button when a restroom has been serviced.

As shown at block 545 of FIG. 5A location system 100 may include means, such as analytic engine 130, processor 305, or the like for transmitting analytic data correlated to at least one of the event, periodic data, predictive analytic data, or the like to visualization system, for example visualization engine 150. In some embodiments, the visualization system is configured to generate graphics, displays, visualizations, diagrams, or the like. For example, visualization engine 150 may generate a heat map to depict the location of each popcorn vendor proximate a monitored area.

At block 550 of FIG. 5A location system 100 may include means, such as central processor/hub 108, processor 305, or the like for outputting the analytic data. For example, visualization engine 150 may generate a diagram to depict the relation between one or more mascots.

In further examples, as shown at block 555 for FIG. 5A, location system 100 may include means, such as analytic engine 130, processor 305, or the like for calculating a location summary based on the sensor position data. For example, analytic engine 130 may calculate a location summary based on the sensor position data for each mascot proximate a monitored area.

As shown at block 560 of FIG. 5A location system 100 may include means, such as analytic engine 130, processor 305, or the like for outputting analytic data based on the location summary. For example, visualization engine 150 may depict the location of reported incidents, issues, and/or the like. Visualization engine 150 may further depict periodic data based on at least one of tag location data or sensor position data. For example, visualization engine 150 may show periodic data, such as the response time, time of arrival, time of departure, duration of stay, etc., of each medical personnel located within Concourse A based on sensor position data calculated by analytic engine 130.

At block 565 of FIG. 5B, location system 100 may include means, such as central processor/hub 108, processor 305, or the like for tracking at least one of the tag location data, sensor position data, or one or more providers simultaneously. For example, alert module 135 may generate an alert when identical mascots are within (or near) the same monitored area.

As shown at block 570, location system 100 may include means, such as tag 102 for transmitting an event indication to verify an event. In some embodiments, event indications may be transmitted in real time (or near real time) to verify the provider performance, an event, etc. In other embodiments, location system 100 may include means such as tag 102 to generate a signal via one or more buttons, links, icons, and/or the like to verify provider performance and/or event indications. For example, a vendor may press an event button after taking an order from an patron.

### Process for Allocating One or More Providers to a Monitored Area

FIG. 6 shows an example method, namely process 600, that may be executed by one or more machines (some examples of which are discussed in connection with FIGS. 1-3) to allocate one or more providers to a monitored area based on at least one of an event, predictive analytic data, and/or the like using a location system in accordance with some embodiments of the present invention. As shown in block 610 of FIG. 6, an apparatus such as location system 100, may include means, such as analytic engine 130, processor 305, or the like for transmitting a request. The request may be defined by at least one of the provider location data, tag location data, and/or the like. For example, analytic engine 130 may transmit a dispatch request for police services during a terrorist threat to alert module 135.

As shown in block 620 of FIG. 6, an apparatus such as location system 100, may include means, such as analytic engine 130, processor 305, or the like for determining predictive analytic data based on at least one of the request, the event, provider data, demographic data, weather data, transaction data, experience data, the periodic data, or one or more rules. For example, analytic engine 130 may determine predictive analytic data predicting the need for medical personnel, such as ambulatory services, when the request relates to terrorism as required by one or more rules stored in rules database 105.

At block 630 of FIG. 6, location system 100 may include means, such as alert module 135, processor 305, or the like for generating an alert based on at least one of tag location data, provider location data, provider supply, analytic data, or demand. The alert may include at least one of a text message, a promotion, an email, an invitation, a message, or a notification. For example, alert module 135 may generate an alert based on the dispatch request received from the analytic engine for police services during a terrorist threat.

As shown in block 640 of FIG. 6, the alert may be transmitted to application device 180 and/or to one or more systems. For example, alert module 135 may transmit the request for emergency services to RF devices held by police personnel proximate the monitored area.

### Process for Outputting an Audio Event

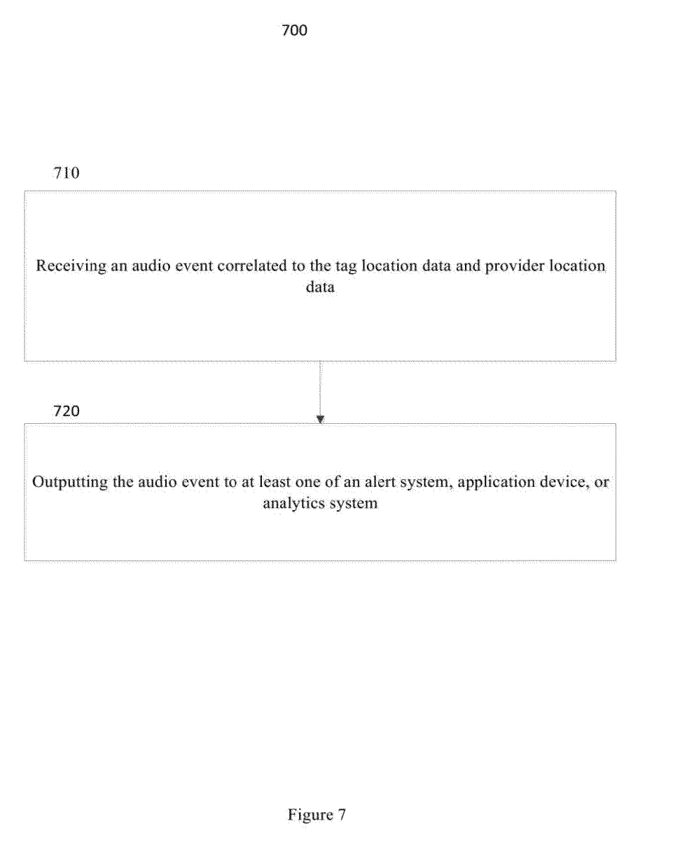

FIG. 7 shows an example method, namely process 700, that may be executed by one or more machines (some examples of which are discussed in connection with FIGS. 1-3) to output an audio event in accordance with some embodiments of the present invention. As shown in block 710 of FIG. 7, an apparatus such as location system 100, may include means, such as audio module 140, processor 305, or the like for receiving an audio event correlated to tag location data, provider location data, and/or the like. For example, a mascot may speak a request for emergency services into an audio receiver, such as a microphone. The audio module 140 may receive the request for emergency services.

In other embodiments, as shown in block 720 of FIG. 7, an apparatus such as location system 100, may include means, such as audio module 140, processor 305, or the like for outputting the audio event to alert module 140, application device 180, analytic engine 130, and/or the like. For example, audio module 140 may be further configured to output the request for emergency services to the application device 180 held by security personnel. In other examples, the request for emergency services may be transmitted to alert module 140.

In some embodiments, certain ones of the operations above may be modified or further amplified as described below. Moreover, in some embodiments additional optional operations may also be included. It should be appreciated that each of the modifications, optional additions or amplifications below may be included with the operations above either alone or in combination with any others among the features described herein.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method comprising:
receiving blink data comprising at least a tag unique identifier from a tag;
calculating, using a processor, tag location data, wherein the tag location data is based on the blink data; and
correlating the tag location data to provider location data.

2. The method of claim 1 further comprising:
aggregating demand;
correlating the demand to the tag location data and the provider location data; and
generating experience enhancement data based on the demand correlated to the tag location data and the provider location data.

3. (canceled)

4. The method of claim 2 further comprising:
utilizing the experience enhancement data to generate analytic data, wherein the analytic data comprises at least one of provider data, transaction data, or experience data; and
calculating, using the processor, provider supply based on the analytic data.

5-6. (canceled)

7. The method of claim 1 further comprising:
generating, using the processor, historical analytic data; and
generating, using the processor, predictive analytic data, wherein the historical analytic data and the predictive analytic data are based on at least one of the tag location data, the provider location data, or monitored individual location data.

8-9. (canceled)

10. The method of claim 1, further comprising:
generating an alert based on at least one of tag location data, provider location data, provider supply, analytic data, or demand, wherein the alert comprises at least one of a text message, a promotion, an email, an invitation, a message, or a notification;
transmitting the alert; and
outputting the alert.

11-13. (canceled)

14. The method of claim 4 further comprising:
allocating the provider supply based on demand; and
distributing the provider supply.

15. The method of claim 14 further comprising:
reallocating the provider supply based on the demand.

16-51. (canceled)

52. An apparatus comprising at least one processor and at least one memory including computer program code, the at least one memory and the computer program code configured to, with the processor, cause the apparatus to at least:
receive blink data comprising at least a tag unique identifier from a tag;
calculate, using a processor, tag location data, wherein the tag location data is based on the blink data; and
correlate the tag location data to provider location data.

53. The apparatus of claim 52, wherein the at least one memory and the computer program code are further configured to, with the processor, cause the apparatus to:
aggregate demand;
correlate the demand to the tag location data and the provider location data; and
generate experience enhancement data based on the demand correlated to the tag location data and the provider location data.

54. (canceled)

55. The apparatus of claim 53, wherein the at least one memory and the computer program code are further configured to, with the processor, cause the apparatus to:
utilize the experience enhancement data to generate analytic data, wherein the analytic data comprises at least one of provider data, transaction data, or experience data; and
calculate, using the processor, provider supply based on the analytic data.

56-57. (canceled)

58. The apparatus of claim 52, wherein the at least one memory and the computer program code are further configured to, with the processor, cause the apparatus to:
generate, using the processor, historical analytic data; and
generate, using the processor, predictive analytic data, wherein the historical analytic data and the predictive analytic data are based on at least one of the tag location data, the provider location data, or monitored individual location data.

59-60. (canceled)

61. The apparatus of claim 52, wherein the at least one memory and the computer program code are further configured to, with the processor, cause the apparatus to:
generate an alert based on at least one of tag location data, provider location data, provider supply, analytic data, or demand, wherein the alert comprises at least one of a text message, a promotion, an email, an invitation, a message, or a notification;
transmit the alert; and
output the alert.

62-64. (canceled)

65. The apparatus of claim 55, wherein the at least one memory and the computer program code are further configured to, with the processor, cause the apparatus to:
allocate the provider supply based on demand; and
distribute the provider supply.

66. The apparatus of claim 65, wherein the at least one memory and the computer program code are further configured to, with the processor, cause the apparatus to:
reallocate the provider supply based on the demand.

67-102. (canceled)

103. A computer program product comprising at least one non-transitory computer-readable storage medium having computer-executable program code portions stored therein, the computer-executable program code portions comprising program code instructions for:
receiving blink data comprising at least a tag unique identifier from a tag;
calculating, using a processor, tag location data, wherein the tag location data is based on the blink data; and
correlating the tag location data to provider location data.

104. The computer program product of claim 103 further comprising program code portions for:
aggregating demand;
correlating the demand to the tag location data and the provider location data; and
generating experience enhancement data based on the demand correlated to the tag location data and the provider location data.

105. (canceled)

106. The computer program product of claim 104 further comprising program code portions for:
utilizing the experience enhancement data to generate analytic data, wherein the analytic data comprises at least one of provider data, transaction data, or experience data; and
calculating, using the processor, provider supply based on the analytic data.

107-108. (canceled)

109. The computer program product of claim 103 further comprising program code portions for:
generating, using the processor, historical analytic data; and
generating, using the processor, predictive analytic data, wherein the historical analytic data and the predictive analytic data are based on at least one of the tag location data, the provider location data, or monitored individual location data.

110-111. (canceled)

112. The computer program product of claim 103, further comprising program code portions for:
generating an alert based on at least one of tag location data, provider location data, provider supply, analytic data, or demand, wherein the alert comprises at least one of a text message, a promotion, an email, an invitation, a message, or a notification;
transmitting the alert; and
outputting the alert.

113. (canceled)

116. The computer program product of claim 106 further comprising program code portions for:
allocating the provider supply based on demand; and
distributing the provider supply.

117. The computer program product of claim 116 further comprising program code portions for:
reallocating the provider supply based on the demand.

118-153. (canceled)
